(19) United States
(12) Patent Application Publication
(10) Pub. No.: US 2026/0288894 A1
(43) Pub. Date: Sep. 24, 2026

(54) AUTOMATED EXTRACTION LOGIC GENERATION TO ENHANCE COMPUTING INFORMATION EXTRACTION

(71) Applicant: Microsoft Technology Licensing, LLC, Redmond, WA (US)

(72) Inventors: Tamanna NAYAK, Hyderabad (IN); Rajiv Kumar NISTALA, Hyderabad (IN); Priyanka BHAYANA, Hyderabad (IN); Garv Sunil GHAI, Mumbai (IN); Anudeep JONNALA, Hyderabad (IN); Karan Veer Singh Bagga, Hyderabad (IN)

(21) Appl. No.: 19/082,917

(22) Filed: Mar. 18, 2025

(51) Int. Cl. G06F 16/957; G06F 8/41; G06F 40/117

(52) U.S. Cl. CPC G06F 16/9577; G06F 8/43; G06F 40/117

(57) ABSTRACT

Various embodiments discussed herein relate to generating, via a language model, extraction logic to extract parameters from data sources, and using these parameters to generate alternative options or recommendations. Various embodiments operate in offline and/or online/runtime modes. In offline mode, data samples are collected from URLs, webpages, app pages, and/or emails, and extraction logic (for example, regexes, XPath, CSS selectors, or executable code for emails) is generated. The extraction logic is stored with domain-specific metadata for efficient retrieval. In online mode, data sources are detected in real-time, and the stored extraction logic is applied to extracted parameters. The parameters are then passed to an API to determine alternative options or recommendations, which are presented as notifications or contextual suggestions.

### BACKGROUND

In modern computing environments, information extraction is useful for processing data from diverse data sources such as Uniform Resource Locators (URLs), webpages, or other content. These data sources often contain structured or semi-structured data. Such data may be extracted to power applications like personalized recommendations, price comparisons, or automated workflows. While extracted data is useful for enabling these applications, existing information extraction technologies rely on static, manually created rules that are difficult to scale, prone to breaking when formats change, and require significant maintenance efforts, among many other technical problems.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Various embodiments discussed herein are directed to generating, via a language model, extraction logic to extract parameters from data sources (for example, URLs, webpages, app pages, and emails), and using these parameters to generate alternative options or recommendations. In an example, extraction logic refers to the rules, patterns, scripts, or computer instructions used to identify and retrieve specific data from data sources. For example, extraction logic includes regular expressions (regexes) for parsing URLs, or custom scripts for parsing documents. Various embodiments operate in offline and/or online/runtime modes, ensuring scalable and accurate parameter extraction while maintaining low computing latency and high responsiveness during runtime.

In the offline mode, some embodiments first collect data samples from multiple data sources, including URLs from browser logs, HTML content from webpages, screenshots from app pages, and emails from booking confirmations. For example, it collects a set of URLs accessed on travel-related websites or emails received from airlines or hotels. Some embodiments then generate extraction logic using a language model (for example, a Large Language Model [LLM]), which leverages its text generation capabilities to create rules and patterns for extracting parameters from the collected data samples. Depending on the data source, the extraction logic may include regular expressions (regexes) for URLs, XPath or CSS selectors for webpages, custom scripts for emails, and/or any other suitable extraction logic. For example, the LLM generates a regex to extract source and destination codes from travel-related URLs or an XPath to extract price information from an HTML page.

After generating the extraction logic, the extraction logic is stored in a centralized repository and/or tagged with metadata, including the corresponding domain or subdomain (for example, flights.example.com), data type (for example, URL, HTML, or email), and validation status. This structured storage enables domain-specific retrieval at runtime and ensures that the extraction logic is reusable and adaptable across similar data patterns.

In the online or runtime mode, some embodiments detect data sources in real-time as users interact with websites, app pages, and/or emails. For instance, when a user navigates to flights.example.com to search for flights, some embodiments detect the URL and retrieve the relevant corresponding extraction logic from the repository that was generated offline. It then applies the extraction logic to the live data source, extracting relevant parameters such as source, destination, date, and price. This ensures accurate and efficient extraction by leveraging the domain-specific logic generated offline.

Once the parameters are extracted, some embodiments call an Application Programming Interface (API) to determine alternative options or recommendations. For example, if the extracted parameter is a flight price, some embodiments compare it to alternative options available from other airlines or booking platforms. If a cheaper or better option is found, for example, some embodiments generate an output such as a floating notification widget alerting the user to the alternative option. Alternatively or additionally, supplemental recommendations are determined and presented. For example, if a user has booked a flight, some embodiments suggest a car rental or hotel with booking information consistent with the flight information.

In light of various information extraction technologies, various embodiments have the technical effect of at least reduced error rate and accurate information extraction, reduced processor load, less memory consumption, increased processing speed, simplified software development, improved usability, and reduced likelihood of data entry errors, as described in more detail below.

### BRIEF DESCRIPTION OF THE DRAWINGS

The present disclosure is described in detail below with reference to the attached drawing figures, wherein:

FIG. 1 is a block diagram depicting an example computing system architecture suitable for implementing some embodiments of the disclosure;

FIG. 2 illustrates a pipeline for processing regex extraction logic from URL sources, according to some embodiments;

FIG. 3 illustrates a pipeline for processing selector extraction logic from web or app sources, according to some embodiments;

FIG. 4 illustrates a pipeline for processing code extraction logic from emails, according to some embodiments;

FIG. 5 is a screenshot representing an example user interface page, according to some embodiments;

FIG. 6 is a screenshot representing an example user interface, according to some embodiments;

FIG. 7 is a flow diagram of an example process for tuning a language model to generate extraction logic, according to some embodiments;

FIG. 8 is a flow diagram of an example process for generating and storing extraction logic offline in preparation for processing data during a future runtime process, according to some embodiments;

FIG. 9 is a flow diagram of an example process for extracting a parameter from a data source and determining an alternative option or recommendation during runtime, according to some embodiments;

FIG. 10 is a block diagram illustrating an example operating environment suitable for implementing some embodiments of the disclosure; and

FIG. 11 is a block diagram of an example computing device suitable for use in implementing some embodiments described herein.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a stand-alone application, a service or hosted service (stand-alone or in combination with another hosted service), or a plug-in to another product, to name a few.

As described above, existing information extraction technologies have many technical problems because they rely on static, manually created rules that are difficult to scale, are prone to breaking when formats change, and require significant maintenance efforts. Manually creating data extraction logic (for example, regexes, XPaths, scripts, etc.) for every possible domain, subdomain, or data structure is error-prone, time-intensive, and lacks scalability. Websites, emails, and other structured or semi-structured data sources frequently change their formats, rendering hard-coded solutions brittle and requiring constant manual updates.

Moreover, extracting relevant data in real-time from live user interactions (for example, URLs, HTML pages, or emails) is computationally complex and resource-intensive with existing information extraction technologies due to variability in data formats and the need to retrieve context-sensitive recommendations while minimizing latency. Each website, email template, URL structure, or other data source may use different conventions for representing the same type of information, requiring adaptive extraction logic. Additionally, real-time processing demands low latency to ensure seamless user experiences, meaning that data must be extracted, interpreted, and used to retrieve relevant recommendations quickly. Performing these operations efficiently while handling format inconsistencies, dynamic content, and response time constraints makes real-time data extraction resource-intensive and technically complex for existing technologies.

Existing information extraction technologies also handle a single type of data source using separate workflows, leading to inefficiencies and lack of interoperability. A unified framework is technically challenging because these data types differ in structure and extraction requirements. Further, websites, email templates, and other data structures frequently change, requiring constant manual updates to the extraction logic, which is inefficient and prone to delays.

Various embodiments employ various technical solutions that have technical effects in light of these technical problems described above. In operation, various embodiments first collect or obtain a data sample from multiple data sources. For instance, data samples are collected by extracting real-world examples from browser logs (URLs), scraped webpages (HTML), and parsed email content, which are then labeled with expected extracted logic for training and/or prompt engineering a language model. In an illustrative example, suppose the system needs to extract flight prices and booking details from multiple sources, including URLs, HTML pages, and emails. For URL parsing, for instance, some embodiments collect URL data samples from browser activity logs or travel search queries. For instance, a first URL sample may be: “https://exampletravel.com/search?source=SFO&destination=LAX&date=2025-06-15&price=450.”

Some embodiments then generate, via text generation of a language model, extraction logic for each data sample from the data sources. In an illustrative example, some embodiments provide the language model the first URL sample and a prompt as input, where the prompt reads “Generate a regular expression to extract ‘source,’ ‘destination,’ and ‘date’ from the following URL pattern” (which corresponds to the first URL sample illustrated above). The generative output of the language model can be, for instance, a regex such as “source=(\w{3})&destination=(\w{3})&date=(\d{4}-\d{2}-\d{2}).” The extraction logic may be any suitable extraction logic, such as a regex, an Extensible Markup Language Path (XPath) selector, a Cascading Style Sheets (CSS) selector, or any other suitable extraction logic.

In response to the language model generating the extraction logic, some embodiments then store the extraction logic in a repository in preparation for runtime queries. The extraction logic is associated with at least one corresponding domain or subdomain for subsequent retrieval. For instance, the repository could be a relational database (for example, SQL) or a NoSQL database (for example, MongoDB), with each extraction logic entry stored in a data record (for example, a row) that links the logic to the corresponding domain or subdomain. For example, particular embodiments use a lookup structure, hash map, or other data structure to store a key representing the domain or subdomain (for example, the website “travel.example.com”), which is then mapped to a corresponding extraction logic value (for example, “source=(\w{3})&destination=(\w{3})&date=(\d{4}-\d{2}).”

Subsequent to the storing of the extraction logic in the repository, some embodiments then detect a data source accessed by a user device during runtime (for example, a URL accessed via a browser or app, an HTML page rendered in a browser or app, or an email received by a user of the user device). For instance, some embodiments monitor relevant activity, such as URLs accessed in a browser or app, webpages rendered in the Document Object Model (DOM), or emails retrieved by the user's email client. For URLs, some embodiments monitor network requests or browser logs to identify the active domain and query string. For HTML pages, some embodiments inspect the rendered DOM to detect elements containing target data. For emails, some embodiments monitor the email client to capture incoming emails and their content. In an illustrative example, if a user visits “https://travel.example.com/flights?source=SFO&destination=LAX,” some embodiments detect the domain “travel.example.com,” parse the URL, and retrieve the corresponding regex logic to extract parameters like source=SFO and destination=LAX.

In response to the detecting of the data source accessed by the user device during runtime, some embodiments then retrieve the extraction logic stored in the repository and responsively extract one or more parameters by applying the extraction logic to the detected data source. For instance, some embodiments match, via a regular expression (regex), a key in the regex to a key in the URL (for example, via fuzzy matching) and responsively extract a value representing the parameter in the URL. In an illustrative example, the regex pattern source=(\w{3})&destination=(\w{3})&date=(\d{4}-\d{2}-\d{2}) is applied to the URL https://flights.example.com/search?source=SFO&destination=LAX&date=2025-01-23.“source=” is matched to the word “source” in the URL. Some embodiments then match “destination=” to the key “destination,” and “(\w{3})” captures the value “LAX.” Some embodiments then match “date=” and captures “2025-01-23” using “(\d{4}-\d{2}-\d{2}).” Some embodiments then output the extracted parameters in a structured format, such as:
{
   “source”: “SFO”,
   “destination”: “LAX”,
   “date”: “2025-01-23”
}.

In response to the extracting of the parameter(s), some embodiments provide the extracted parameter to an external system that is configured to generate an alternative option or recommendation relative to the parameter. For example, some embodiments detect and extract the parameters “source=SFO,” “destination=LAX,” and “date=2025-01-23” using the corresponding regex. Some embodiments then provide these extracted parameters to an external backend API that is configured to search for alternative travel options. The API responds with recommendations such as a cheaper flight, an earlier departure time, or fewer layovers, which the system presents to the user as optimized booking options. This interaction enables dynamic updates without requiring user intervention, enhancing travel planning efficiency.

As described above, existing information extraction technologies require the manual creation of extraction logic, which is difficult to scale, prone to breaking when formats change, and requires significant maintenance efforts. One technical solution is the use of a language model (for example, an LLM or a Small Language Model (SLM)) to automatically generate extraction logic. This solution allows for technical effects of dynamic adaptation to a wide variety of domains (for example, travel sites, ticketing platforms, etc.), scalability by using the same automated framework to handle new domains or changing formats, and reduction in manual labor and error rates by replacing manually driven hand-coded logic with machine-generated (and/or validated) extraction logic.

As described above, extracting relevant data in real-time from live user interactions (for example, URLs, HTML pages, or emails) is computationally complex and resource-intensive with existing information extraction technologies. One technical solution of various embodiments is the integration of “offline” functionality to generate extraction logic with “online” real-time retrieval of the extraction logic. In the offline phase, various embodiments collect (and/or train and/or validate on) sample data source(s), which is provided to a language model as input for generating extraction logic, allowing for efficient real-time deployment without repeated computation. This generated extraction logic is also stored to a repository for later retrieval. In the online phase, various embodiments detect a data source (for example, via domain detection) accessed by a user device during runtime and apply the extraction logic to the live data source. This separation improves system performance and responsiveness while maintaining accuracy. Specifically, separating the extraction process into offline and online phases reduces computational complexity and resource consumption by shifting heavy processing tasks (for example, the generation of the extraction logic by the language model) to the offline phase while keeping the online phase lightweight and efficient (for example, because it need only access the extraction logic and not generate it). In the offline phase, the system generates and/or validates extraction logic (for example, regexes, XPaths, scripts, etc.) based on historical data, eliminating the need for real-time computation of extraction rules. This reduces the burden on the system during live interactions. In the online phase, instead of dynamically generating new extraction logic for every request, the system retrieves and applies the extraction logic, significantly reducing processing time and latency. This separation also minimizes CPU load, memory usage, and network bandwidth demands, ensuring fast response times while maintaining accuracy in real-time extraction. By shifting computationally intensive tasks like extraction logic generation and validation to the offline phase, the system avoids real-time processing overhead, reducing CPU load and memory usage during live interactions. In the online phase, retrieving and applying precomputed extraction logic eliminates the need for dynamic computation and large data transfers (for example, because the extraction logic has already been generated), thereby minimizing network bandwidth usage and ensuring fast, accurate real-time extraction.

As described above, existing information extraction technologies also handle a single type of data source (for example, URLs, HTML, or emails) using separate workflows, leading to inefficiencies and lack of interoperability. One technical solution is a unified framework that: leverages a modular approach for generating and applying extraction logic tailored to each data type (for example, regexes for URLs, XPaths for HTML, and scripts for emails), harmonizes outputs into a standard format for downstream processing (for example, providing parameters to APIs), and ensures interoperability across data sources by abstracting the underlying extraction mechanism. As described above, websites, email templates, and other data structures frequently change, requiring constant manual updates to extraction logic, which is inefficient and prone to delays. One technical solution to this is a feedback loop in the system that includes one or more of: using API responses to detect errors or inaccuracies in extraction logic during runtime, or dynamically refining prompts for the language model to generate improved extraction logic, thereby automating the adaptation process and minimizing downtime and manual intervention when formats change. This automation reduces reliance on manual updates, allowing the system to quickly adapt to changes in website structures, email templates, or URL formats without downtime. By iteratively improving extraction accuracy through API-driven feedback, the system ensures robust, self-correcting performance, reducing errors and maintaining reliable real-time data extraction.

There are various other technical effects realized by one or more embodiments of the present disclosure. For example, there is reduced processor load in some instances. By separating the offline and online phases, computationally intensive tasks like generating extraction logic are performed offline, reducing the runtime processor load. During the online phase, pre-generated logic is simply retrieved and applied, minimizing real-time processing requirements. Offline generation of regexes, selectors, or parsing scripts, for example, reduces the need for real-time computation.

Various embodiments also have the technical effect of requiring less memory space. Instead of maintaining large sets of hard-coded rules or constantly recalculating extraction logic, some embodiments use generated (for example, pre-generated) extraction logic stored in a repository, which is much more compact than hard-coded rules. This approach reduces memory usage compared to dynamically creating or generating logic for every request at runtime.

Various embodiments also have the technical effect of increased processing speed. The separation of offline and online phases improves real-time processing speed. By retrieving pre-validated logic during runtime, the system avoids the overhead of generating and/or validating extraction logic in real-time, thus reducing the number of processing steps.

Various embodiments also have the technical effect of simplified software development. Some embodiments automate the generation of extraction logic (for example, via a language model and/or through machine learning), which reduces the need for developers to manually write and update rules, significantly simplifying software development and maintenance. For example, LLM-generated extraction logic automates a traditionally manual, error-prone process, reducing developer workload.

Various embodiments also have the technical effect of improved usability. By automating the extraction and presentation of relevant information (for example, cheaper flights, tailored itineraries, etc.), the system improves the user's experience by providing contextually relevant data seamlessly. For example, with respect to email parsing, automatically displaying (or otherwise generating an output of) extracted booking details as a travel card or notification enhances usability by reducing the need for manual searches. In another example, for HTML price extraction, notifications of better (or more optimal) prices presented directly to users improves the efficiency of decision-making.

Various embodiments also have the technical effect of reduced likelihood of data entry errors. By automatically extracting parameters and/or pre-populating forms (for example, booking or travel services), this eliminates the need for users to manually enter data, reducing the chance of errors. For example, with respect to HTML price extraction, various embodiments reduce errors when comparing prices or booking options. In other words, for example, some embodiments reduce errors in HTML price extraction by using automated extraction logic (for example, XPaths or CSS selectors) that precisely targets pricing elements within a webpage's DOM structure, eliminating inconsistencies caused by manual or rule-based approaches. By leveraging a unified framework, some embodiments standardize extracted price data into a consistent format, ensuring accurate comparisons across different booking platforms. Additionally, the feedback loop detects incorrect extractions by cross-checking API responses, allowing the system to dynamically refine extraction logic when webpage structures change. This minimizes misinterpretations of prices, incorrect currency conversions, and missing data, ensuring reliable and error-free price comparisons for booking decisions.

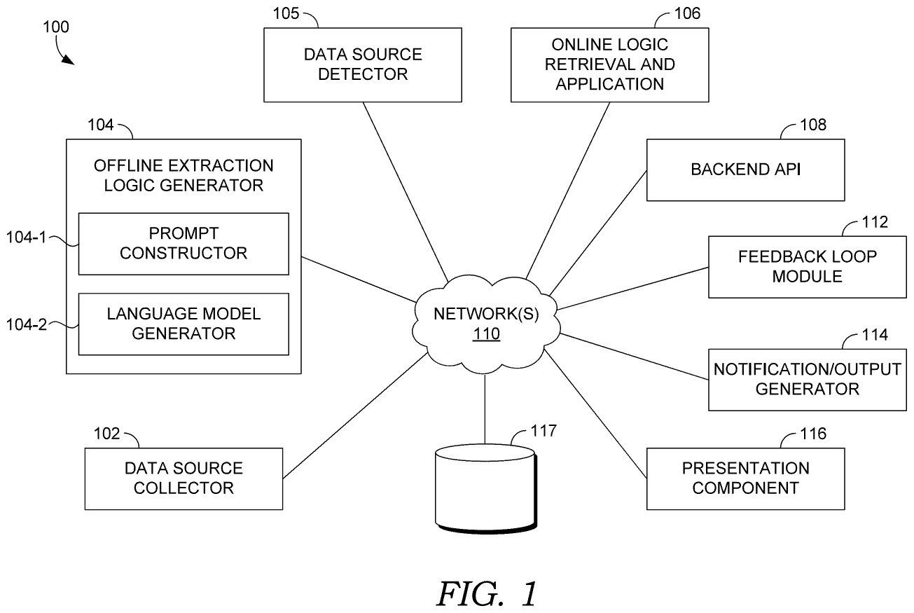

Turning now to FIG. 1, a block diagram is provided showing aspects of an example computing system architecture suitable for implementing some embodiments of the disclosure and designated generally as system 100. The system 100 represents only one example of a suitable computing system architecture. Other arrangements and elements can be used in addition to or instead of those shown, and some elements are omitted altogether for the sake of clarity. Further, as with system 100, many of the elements described herein are functional entities that are implemented as discrete or distributed components or in conjunction with other components, and in any suitable combination and location according to various embodiments.

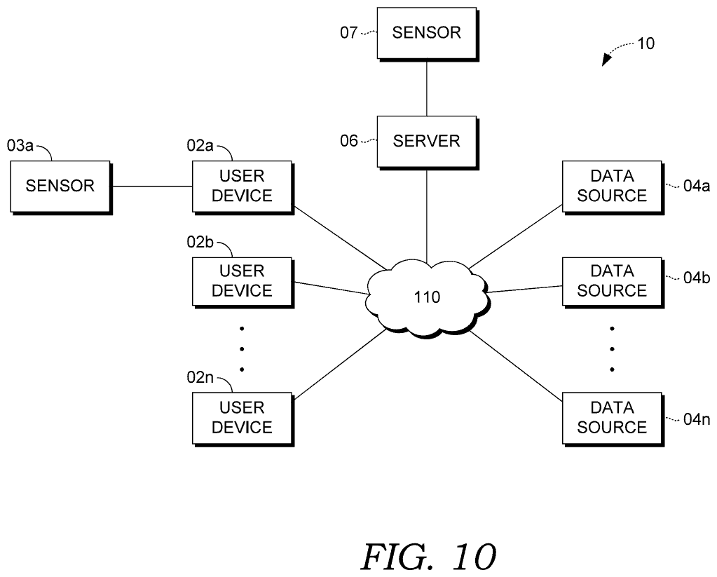

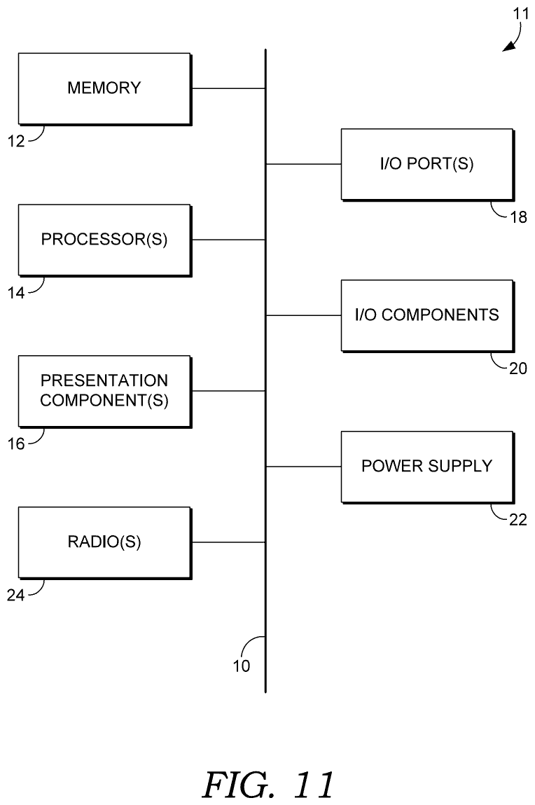

Example system 100 includes network(s) 110, which is described in connection to FIG. 10, and which communicatively couples components of system 100 including storage 117. The system 100 is generally responsible for generating extraction logic to extract one or more parameters and providing one or more alternative options or recommendations. The system 100 includes a data source collector 102, an offline extraction logic generator 104, a data source detector 105, an online logic retrieval and application 106, a backend API 108, a feedback loop module 112, a notification/output generator 114, a presentation component 116, and storage 117, each of which is communicatively coupled via one or more networks 110 (for example, a Wide Area Network [WAN], Local Area Network [LAN], a Personal Area Network [PAN], or a cloud-based network). In some embodiments, these components in the system 100 are embodied as a set of hardware circuitry components (for example, a hardware accelerator, such as a GPU AI hardware accelerator), compiled computer instructions or functions, program modules, computer software services, a combination thereof, or an arrangement of processes carried out on one or more computer systems, such as computing device 11 described in connection to FIG. 11, and the user device 02a and/or the server 06 of FIG. 10, for example.

In some embodiments, the functions performed by components of system 100 are associated with one or more personal assistant applications, services, or routines. In particular, such applications, services, or routines can operate on one or more user devices (such as user device 02a of FIG. 10), and servers (such as server 06 of FIG. 10) can be distributed across one or more user devices and servers, or can be implemented in the cloud. Moreover, in some embodiments, these components of system 100 are distributed across a network, including one or more servers (such as server 06 of FIG. 10) and client devices (such as user device 02a of FIG. 10), in the cloud, or can reside on a user device, such as user device 02a of FIG. 10. Moreover, these components, functions performed by these components, or services carried out by these components are implemented at appropriate abstraction layer(s) such as the operating system layer, application layer, and/or hardware layer of the computing system(s). Alternatively, or in addition, in some embodiments, the functionality of these components and/or the embodiments described herein are performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), and Complex Programmable Logic Devices (CPLDs). Additionally, although functionality is described herein with regards to specific components shown in example system 100, it is contemplated that in some embodiments, functionalities of these components are shared or distributed across other components.

Continuing with FIG. 1, the data source collector 102 is generally responsible for collecting sample data (for example, URLs, webpages, and emails) from various domains and subdomains to create a dataset that is used to train or prompt engineer a large language model (LLM). For example, in some embodiments, the data source collector 102 monitors browser activity on the user's device or through server-side logs to detect interactions with travel-related domains. When a user accesses a URL (for example, https://travel.example.com/flights?source=SFO&destination=LAX), the data Source collector 102 records the URL along with metadata, such as the domain and query parameters. A lightweight browser extension can capture URL requests locally and send them to storage 117. On server-side systems (for example, enterprise environments), proxy servers or network monitoring tools can log outbound requests and collect samples. Additionally or alternatively, in some embodiments, logs maintained by the browser itself (for example, browsing history or developer network logs) are used as a source to extract visited URLs, capturing direct user interactions with websites. In some embodiments, collected URLs are categorized by domain or subdomain and stored in storage 117.

In some embodiments, the data source collector 102 collects sample HTML pages (or other webpages) via web scraping. For example, the data source collector 102 uses web crawlers and scrapers to navigate and extract content from webpages associated with travel booking sites (for example, airline or hotel websites). For instance, a web crawler (for example, built using tools like Scrapy, Selenium, or BeautifulSoup) systematically traverses webpages starting from known travel-related domains. It follows internal links to access relevant booking pages, flight search results, or hotel listings. For each visited page, the system scrapes HTML content and captures DOM elements containing prices, dates, or booking options, for example. The HTML snippets (for example, containing price or travel data) are extracted and stored.

In some embodiments, the data source collector 102 collects sample emails via Email Client Integration. In this process, the data source collector 102 collects mails by integrating with the user's email client or email server and retrieving particular data, such as booking confirmation emails or itineraries. In some embodiments, the data source collector 102 integrates with email services (for example, Gmail, Outlook, etc.) via IMAP or POP3 protocols or by using email client APIs (for example, Gmail API, Microsoft Graph API, etc.). Travel-related emails, for example, are filtered by subject lines, sender domains, or specific keywords (for example, “Flight Confirmation”). In some embodiments, the data source collector 102 periodically scans for and retrieves new emails (for example, related to travel bookings). For example, extracted email content includes the subject line, body text, and metadata (for example, sender and date). In some embodiments, preprocessing occurs when the email content is parsed to remove boilerplate text or irrelevant information. The body of the email is broken down into annotated text segments containing booking details (for example, flight numbers or prices).

In some embodiments, the data source collector 102 stores the collected samples in a centralized repository (for example, a relational database or NoSQL system), such as storage 117. After sample collection, in some embodiments, the collected samples are annotated or preprocessed to help a language model learn patterns and structures for generating effective extraction logic (for example, regexes, XPaths, or scripts). In some embodiments, each data sample collected from the data source collector 102 is labeled with the extraction logic that would be used to extract the parameters. For example, a raw URL may be labeled with a particular regex, an HTML snippet may be labeled with an XPath selector, or email content can be labeled with a regex.

The offline extraction logic generator 104 is generally responsible for generating extraction logic (for example, regexes, XPaths, CSS selectors, or scripts) using a language model that is prompt-engineered and/or trained (for example, fine-tuned) with domain-specific data. In some embodiments, the inputs to the language model include URLs, HTML content, and/or sample emails collected offline from the data source collector 102, and/or predefined prompts to guide the language model. The output is extraction logic (for example, regex patterns, XPaths, scripts, etc.) stored in a database for future use.

The offline extraction logic generator 104 includes a prompt constructor 104-1 and a language model generator 104-2. The prompt constructor 104-1 is generally responsible for dynamically constructing context-specific prompt(s) to guide the language mode in generating accurate extraction logic tailored to URLs, HTML pages, emails, and/or other content. In some embodiments, the inputs include data samples collected by the data source collector 104 (for example, annotated URLs, HTML snippets, or emails), and/or predefined templates or prompt templates, which define the structure of the prompts to be constructed. For example, a template may be, “Given this sample URL/HTML/email, generate extraction logic to identify [parameters] from the content.” In some embodiments, the prompt constructor 104-1 inspects the data samples to identify contextual information required for prompt construction. For example, for URLs, extract the domain/subdomain and identify which parameters to extract (for example, source, destination, date, etc.). For HTML, determine the target data (for example, price, departure time) and relevant DOM elements. For Emails, identify the key information such as booking references, flight numbers, or travel dates.

The prompt constructor 104-1 selects or constructs a prompt template based on the type of data (URL, HTML, or email), and dynamically fills in contextual details from the training sample. For example, the prompt constructor 104-1 first detects the data type using heuristics or Natural Language Processing (NLP)-based classifiers. It then selects the appropriate prompt template based on the detected data type (URL, HTML, or email). The prompt constructor 104-1 then dynamically fills the template using contextual details extracted from the sample, employing, for example, pattern matching, DOM analysis, or Named Entity Recognition (NER) techniques. For example, a completed prompt might be, “Given the following URL: https://travel.example.com/search?source=SFO&destination=LAX&date=2025-06-15, generate a regular expression to extract: source, destination, and date.” The completed prompt is then fed to the language model generator 104-2, which generates tailored extraction logic for future use.

The language model generator 104-2 is generally responsible for taking the constructed prompts output by the prompt constructor 104-1 and generates the extraction logic tailored to the specific data source collected from the data source collector 102 and/or the data source detector 105. In some embodiments, the language model generator 104-2 uses the collected samples (for example, training data) and prompt context to understand the target structure or pattern within the data (for example, key-value pairs in URLs, price elements in HTML, or keywords in emails). For example, before an LLM can generate extraction logic, it is trained or fine-tuned on annotated samples. These samples teach the model to recognize patterns specific to URLs, HTML, and emails, or other content. During training, the model learns to associate: URLs with specific structures like key-value pairs and common patterns (for example, source, destination, date, etc.), HTML elements with structured data representations (for example, flight price nested within <div> tags), and email content with semantic meaning (for example, flight numbers and booking references extracted via NER or regex patterns). The model learns to identify patterns such as: keys in the query string (for example, source=, destination=) or expected values (for example, 3-character IATA codes, date formats, etc.). Through this training process, the model builds internal representations that allow it to generalize across unseen URLs, HTML structures, and email formats.

During inference (runtime), the system provides the LLM with prompts that supply the context and specific instructions for generating extraction logic tailored to the input data type. The prompt describes what to extract and provides an example of the structure. It activates relevant learned patterns from the model's training phase, helping it interpret and generate logic specific to the given input. In some embodiments, the language model generator 104-2 leverages pattern-matching capabilities, attention mechanisms, and/or internal representations developed during training to understand the structure of the input data. For example, an LLM first tokenizes the input (URL, HTML, or email text) into small pieces (tokens) and applies attention mechanisms to understand relationships between these tokens. For URLs, the LLM understands the syntax of query strings (for example, keys and values) based on prior training. For HTML, the LLM recognizes common HTML structures and attributes like ID, class, and nested tags. For emails, the LLM uses its understanding of language and common entities (for example, dates, locations, and flight numbers) to extract relevant details. The model generalizes from training examples and detects patterns in the current sample. For instance, in URLs, the model recognizes that key-value pairs often follow the “?key=value” structure and that IATA codes typically consist of 3 letters. In HTML, it understands that DOM nodes containing prices or travel details are often within div or span tags with descriptive class names. In emails, it detects recurring phrases like “Flight Confirmation” or “Booking Reference” and the format of dates.

Based on the specific task provided in the prompt, the model selectively activates the relevant knowledge. For example, when asked to generate a regex for dates, it focuses on recognizing date formats (for example, YYYY-MM-DD or June 15, 2025), whereas when extracting flight numbers, it looks for alphanumeric patterns. Using its internal understanding, the LLM generates structured extraction logic (for example, regexes, XPaths, or scripts) that corresponds to the specific task. In some embodiments, the generated extraction logic can be validated against additional test data samples to ensure accuracy and robustness before being stored in the repository for future retrieval.

The data source detector 105 is generally responsible for detecting one or more data sources being accessed by a user device at runtime. For example, with respect to detecting URLs, the data source detector 105 detects live URLs when the user accesses webpages via a browser or an app by monitoring browser activity, outgoing HTTP requests, or system logs. A lightweight browser extension (for example, for Chrome, Edge, or Firefox) hooks into the browser's navigation events and captures the current active URL. Browser APIs like the Web Navigation API or History API can also be used to detect URLs as users navigate through webpages. On the server side, in some embodiments the data source detector 105 monitors HTTP GET requests via proxy servers or packet sniffing tools to identify URLs being accessed in real-time. This is especially useful in enterprise environments where a central proxy server handles user requests. In mobile applications, deep linking or in-app routing mechanisms detect which external links or URLs the app is requesting. When the user visits a page (for example, flight search on a travel website), for example, the data source detector 105 detects the current URL. In some embodiments, the data source detector 105 then parses the domain and query string parameters (for example, source, destination, and date) to determine the data context. The detected URL information is passed to the Online Logic Retrieval and Application 106 to fetch the correct regex for parameter extraction.

With respect to detecting webpages (for example, HTML), when the user interacts with a rendered HTML webpage, in some embodiments the data source detector 105 inspects the page's DOM structure to determine the relevant page context and identify target data (for example, prices, flight information, etc.). In some embodiments, the data source detector 105 uses tools like Puppeteer, Selenium, or browser APIs to inspect the DOM (Document Object Model) of the rendered page. It can dynamically traverse the DOM and identify key attributes like ID, class, or tags that indicate where the relevant data is located. In some embodiments, the data source detector 105 inspects HTTP response headers, meta tags, and page titles to understand the webpage context. For example, if the page's title contains “Flight Results” or metadata describes it as a booking page, the system can infer its purpose. In some embodiments, the data source detector 105 uses NLP-based models or rule-based heuristics to analyze visible content and classify the page as related to travel bookings, hotels, or car rentals. As the user navigates to a travel booking page, the system hooks into the browser's navigation and rendering events. In some embodiments, the data source detector 105 inspects specific sections of the page (for example, a div containing prices or booking information) and extracts relevant attributes (for example, id=“price-container”). Based on keywords, structural patterns, or metadata, the data source detector 105 classifies the webpage as belonging to a travel booking or price comparison context in some embodiments.

With respect to email detection, in some embodiments the data source detector 105 integrates with email client APIs (for example, Gmail API, Microsoft Graph API, etc.) to monitor inbox activity and detect incoming travel-related emails. For legacy systems, IMAP/POP3 protocols can be used to periodically scan and retrieve new emails. In some embodiments, the data source detector 105 scans the email subject, sender address, and content to detect emails related to travel bookings or other content. For example, emails with subject lines containing “Flight Confirmation” or from domains like @airline.com are flagged as relevant. In some embodiments, NLP techniques such as NER can be applied to detect important entities within the email (for example, flight numbers, dates, booking references, etc.) to confirm relevance. When a new email arrives or when the user accesses an email, in some embodiments the data source detector 105 monitors the interaction in real-time. The data source detector 105 inspects the email subject, sender, and/or other key phrases within the body to classify the email. Example Phrases are “Flight Confirmation,” “Booking Reference,” or “Your Reservation.” Based on the sender domain and content analysis, the data source detector 105 classifies the email as being related to travel bookings. The data source detector 105 passes the email classification and relevant details (for example, sender domain and content context) to the Online Logic Retrieval and Application for extracting parameters.

The online logic retrieval and application 106 is generally responsible for dynamically retrieving from storage 117 and applying the correct pre-generated extraction logic (for example, regexes, XPaths, CSS selectors, or scripts) to live data sources detected by the data source detector 105 during runtime. This ensures fast, context-aware extraction of parameters (for example, flight details, prices, booking references, etc.) in real-time user interactions.

The online logic retrieval and application queries a repository (for example, a database in storage 117) containing the pre-generated extraction logic for various domains, data types, and contexts. In some embodiments, the repository is indexed by domain, subdomain, and data type (for example, regex for URLs and XPath for HTML). The retrieval system queries the repository using the provided domain and context to locate the correct extraction logic. For example, an SQL Query might be “SELECT extraction_logic FROM logic_repository WHERE domain=‘travel.example.com’ AND data_type=‘URL’.” The online logic retrieval and application component retrieves the correct extraction logic (for example, regex or XPath) associated with the detected domain and data type. The SQL query causes the needed pre-generated extraction logic to be retrieved by leveraging the contextual details provided by the data source detector 105, such as the domain, subdomain, data type (URL, HTML, or email), and relevant attributes. The repository is indexed in some aspects based on these details, allowing the query to filter and match the appropriate extraction logic. For example, if the detector identifies a URL from “travel.example.com,” the query searches for extraction logic tagged with this domain and data type. Additional filtering, such as matching specific query parameters (for example, source, destination, etc.), ensures the correct regex or XPath is retrieved for precise data extraction.

The applying of the extraction logic to the detected data source can occur via any suitable manner. For example, for HTML pages, the XPath or CSS selector engine uses the retrieved XPath or selector to locate elements within the DOM. For emails, the regex engine or custom script processes the email content to extract flight numbers, booking references, or travel dates to extract needed parameter(s).

The backend API 108 is generally responsible for processing the extracted parameter(s) to generate one or more alternative options or recommendations relative to the extracted parameter(s). The inputs are parameter(s) extracted from the data source(s) detected by the data source detector 105 and/or user preferences (for example, loyalty programs, preferred airlines/hotels, etc.). The output is alternative option(s) and/or recommendations (for example, cheaper flights, better routes, hotel upgrades, etc.). The backend API 108 handles tasks like: receiving extracted parameters from URLs, HTML pages, or emails, querying travel-related databases or third-party services (for example, airline, hotel, or car rental APIs), applying user-specific preferences to tailor the results, and/or generating and returning optimized options or recommendations, such as cheaper flights, better routes, or hotel upgrades.

In an illustrative example, the backend API 108 first receives an HTTP POST or GET request containing the extracted parameters from the online logic retrieval and application 106 and optional user preferences. The API 108 then parses the incoming (for example, JSON) request and extracts the key parameters (for example, source, destination, date, price, and user preferences). In some embodiments, the API 108 dynamically constructs queries based on the extracted parameters and preferences. In some aspects, if internal databases are insufficient, the backend API 108 sends API requests to external services (for example, travel services, such as airline booking APIs, hotel reservation systems, etc.). In some embodiments, the API 108 filters the retrieved options based on user preferences, such as: excluding non-preferred airlines, prioritizing options within budget, ranking results based on criteria like price, duration, and loyalty benefits, or the like. The API 108 may apply ranking algorithms or machine learning models to recommend the most optimized option based on: user history (for example, frequent travel routes), current promotions (for example, discounts or loyalty upgrades), context-specific factors (for example, time of day or seasonality), or the like. In some embodiments, the backend API 108 constructs the response in JSON format, which contains the recommended travel options. For example, such a response may be:
{
   “recommended_options”: [
      {
         “flight_number”: “DL123”,
         “airline”: “Delta”,
         “departure”: “2025-06-15T08:00”,
         “arrival”: “2025-06-15T10: 30”,
         “price”: “$400”,
         “stops”: 0,
         “loyalty_bonus”: “2,500 SkyMiles earned”
      },
      {
         “flight_number”: “AA456”,
         “airline”: “American Airlines”,
         “departure”: “2025-06-15T09:00”,
         “arrival”: “2025-06-15T11:45”,
         “price”: “$420”,
         “stops”: 1
      }
   ]
}

The API 108 returns the response to the frontend or user-facing component for display to the user device. The user can then view alternative options and select the preferred option. In some embodiments, the API 108 is designed to handle failures and errors. For example, if external API calls fail or time out, the system retries them with exponential back off. If external APIs are unavailable, the system can fall back to using cached data or partial recommendations. In some embodiments, the API 108 ensures that all extracted parameters are valid and sanitized before querying external services.

The feedback loop module 112 is generally responsible for taking responses from the backend API 108 to refine extraction logic by updating language model prompts or parameters. Inputs may include API responses indicating errors, inconsistencies, or changes in data patterns and initial extraction logic used during runtime. The outputs include updated extraction logic generated by the language model generator 104-2 and stored in storage 117.

The feedback loop module 112 detects and corrects errors or inconsistencies during runtime (for example, when incorrect parameters are extracted or the extraction logic fails to extract expected values); automatically refines and updates extraction logic using the offline extraction logic generator 104, reducing the need for manual intervention when data sources change; and stores updated extraction logic in the repository for future use. During runtime, the feedback loop module 112 continuously monitors API responses from the backend API 108 after sending extracted parameters. If the API 108 returns an error, inconsistency, or other unexpected result, this triggers the feedback mechanism. For example, an API response indicating an error might be:
{
   “error”: “Invalid source location”,
   “details”: “The extracted source ‘ABC’ does not match any known airport codes.”
}

The feedback loop module 112 analyzes the failure to determine the cause, such as whether the extraction logic was unable to detect a key parameter, whether incorrect or partial values were extracted, or whether the data source (for example, the webpage or email) changed its structure, causing the extraction logic to fail. For instance, there may be a URL parsing failure, where the regex failed to extract key query parameters (for example, source or destination), the XPath could no longer locate price elements due to changes in the page's DOM structure, or the booking reference or flight number could not be extracted due to a new email format. Based on the failure analysis, the feedback loop module 112 dynamically constructs or adjusts prompts for the language model to generate updated extraction logic.

With respect to adjusting the prompts, some embodiments add new context or examples to the prompt if the failure was due to inadequate training data, or modify the language model's instructions to focus on a broader or more flexible extraction approach. To adjust the prompts, the feedback loop module 112 analyzes the failure to determine the specific gap in the language model's understanding—whether it's due to missing examples or overly rigid extraction logic by analyzing the extracted output, comparing it to the expected result, and examining API error messages. If the feedback loop module 112 extracts a value but it does not match variations in format or key names (for example, extracting “ABC” instead of “SFO” due to a strict regex that only matches source=), it flags the issue as overly rigid logic. If the system fails to extract any value or encounters a new pattern not covered by the current training data, it is classified as missing examples. Rule-based checks (for example, pattern matching) and/or NLP-based entity recognition help classify the cause, triggering the appropriate prompt refinement strategy.

If the failure is due to inadequate training data, the feedback loop module 112 programmatically calls the prompt constructor 104-1 to enrich the prompt by adding new contextual examples (for example, URLs, HTML snippets, or email formats) that reflect variations not covered previously. If the issue is due to overly narrow logic (for example, failing to handle parameter name variations), the feedback loop module 112 calls the prompt constructor 104-1 to modify the instructions in the prompt to direct the language model to generalize the extraction rules by focusing on flexible matching techniques (for example, handling synonyms like “source” or “from”). The adjusted prompt is then passed to the language model generator 104-2, ensuring that the updated extraction logic is adaptable and robust.

In some embodiments, the feedback loop module 112 validates the updated extraction logic using sample test data before deploying it. It applies the updated logic to test URLs, HTML snippets, email samples, or other content to ensure it correctly extracts parameters across different formats. For example, a validation text may include input: “https://newsite.example.com/query?src=SFO&dest=LAX&trip_date=2025-06-15” where the expected output is “source”: “SFO”, “destination”: “LAX”, and “date”: “2025-06-15.”

If the updated extraction logic passes a validation threshold, the feedback loop module 112 stores it in the centralized repository. The new logic is tagged with the corresponding domain, subdomain, and/or data type for future retrieval. For example, the refined regex, XPath, or custom script generated by the LLM is saved and made available for future use.

The notification/output generator 114 is generally responsible for generating user-facing outputs, such as browser notifications, travel cards, or itinerary enhancements. The inputs are alternative options or recommendations from the backend API 108, and/or extracted parameters (for example, booking details) from the online logic retrieval and application 106. An example output may include, for example, notifications (for example, “Cheaper flight available for $350”), pre-populated booking fields or enhanced itineraries displayed in the user interface (UI), and/or suggested travel experiences, such as tours or restaurants. In another example, the notification/output generator 114 formats the information into browser notifications, travel cards, or UI enhancements, such as displaying alerts for cheaper flights, pre-filling booking forms, or updating itineraries with optimized travel suggestions. Additionally or alternatively, it can suggest related experiences (for example, nearby restaurants or tours) by combining user preferences and contextual travel data to create a seamless and personalized user experience.

The presentation component 116 is generally responsible for dynamically creating and rendering the user interface (UI) (for example, based on the outputs from the notification/output generator 114). It ensures that the extracted parameters, alternative options or recommendations, and notifications are presented to the user in an intuitive and visually appealing format, such as dashboard widgets, pop-up notifications, or travel cards within a booking app. In some embodiments, the presentation component 116 adapts the presentation based on the device type (for example, mobile or desktop) and user preferences to optimize interaction and usability. In an illustrative example, if the notification/output generator 114 produces an alert for a cheaper flight option, the presentation component 116 renders a pop-up notification on the user's browser stating, “Cheaper flight available for $350,” with a button allowing the user to view details or book the flight directly. On a mobile app, the same alert could appear as a travel card embedded within the user's itinerary page.

Example system 100 also includes storage 117. Storage 117 generally stores information including indices, extraction logic, computer instructions (for example, software program instructions, routines, or services), data structures, and/or models used in embodiments of the technologies described herein. In some embodiments, storage 117 represents any suitable data repository or device, such as a database, a data warehouse, RAM, cache, disk, RAID, and/or a storage network (for example, Storage Area Network [SAN]). In some embodiments, storage 117 includes data records (for example, database rows that represent each cluster) or other data structures (for example, key-value pairs) that contain any suitable information described herein. In some embodiments, each record is called or requested and returned over the computer network(s) 110, depending on the component needing it, as described herein.

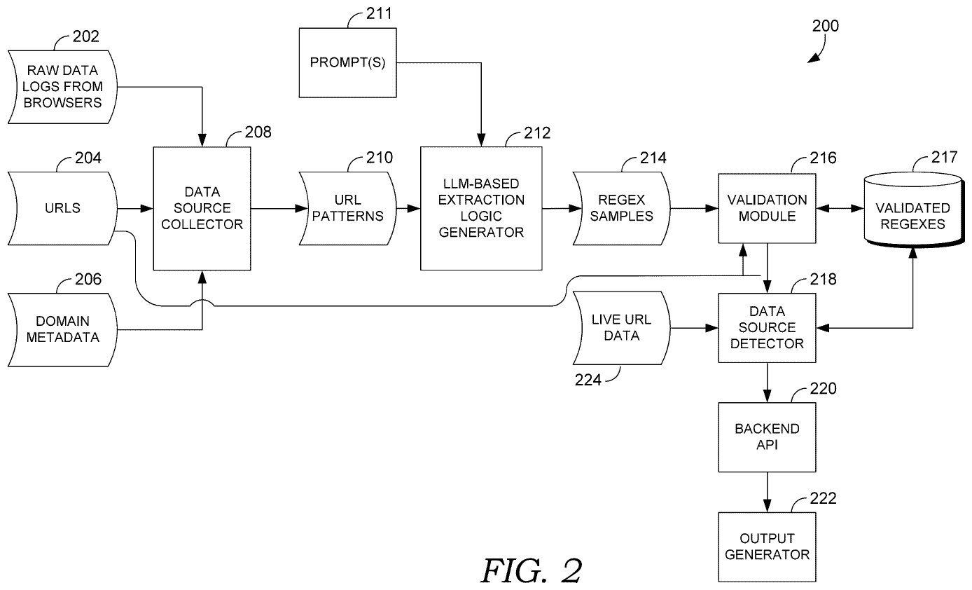

FIG. 2 illustrates a pipeline 200 for processing regex extraction logic from URL sources, according to some embodiments. At a first time, a data source collector 208 (for example, the data source collector 102 of FIG. 1) takes, as input, raw data logs from browsers 202, raw URLs 204 (for example, from travel-related domains, such as airlines, hotels, car rentals, etc.), and domain metadata (for example, subdomain type like “flights” and “hotels”) in order to generate URL patterns 210. The purpose is to gather URL patterns 210 from browser logs or domains to use as training data for generating regexes or use as example input-output pairs (for example, few-shot) for prompt engineering. This component is the entry point of the offline phase, ensuring that sufficient and diverse URL examples are available for regex generation.

First, the data source collector 208 aggregates URLs 204 from sources like airline, hotel, and car rental sites, identifying common structures across different pages (for example, search results or booking pages). Using domain metadata 206, the data source collector 208 groups URLs by subdomain types (for example, “flights.example.com”or “hotels.example.com”) to create context-specific patterns. It then applies pattern recognition techniques, such as identifying recurring parameter keys (source, destination, date, etc.), and generalizes the URL by replacing variable components with placeholders (for example, {source}, {destination}, etc.). The result is a curated dataset of URL patterns 210 (for example, https://flights.example.com/search?source={source}&destination={destination}&date={date}) that can be used by the LLM-based extraction logic generator 212 to generate regexes applicable to a wide variety of URLs.

URL patterns 210 refer to generalized representations of URLs that indicate recurring structures or formats within a set of URLs, rather than referring to individual, specific URLs. A URL pattern typically captures the key structural elements common across multiple URLs, such as parameter keys and their positions, while ignoring (or not including) specific values. This allows the system to generalize extraction logic that works across a variety of URLs from the same or similar domains. For example, individual URLs might be, “https://travel.example.com/search?source=SFO&destination=LAX&date=2025-06-15” or “https://travel.example.com/search?source=JFK&destination=MIA&date=2025-07-10 ,” whereas a URL pattern abstracts the structure of these URLs, highlighting common elements like query parameter names and generalizing variable values. For example, a URL pattern might be, “https://travel.example.com/search?source={source}&destination={destination}&date={date}.”

The LLM-based extraction logic generator 212 (for example, the offline extraction logic generator 104 of FIG. 1) takes, as input, the URL patterns 210, as well as the prompt(s) 211 (for example, as curated by the prompt constructor 104-1) specifying the parameters to extract (for example, source, destination, travel dates, etc.) in order to generate regex samples 214. The LLM-based extraction logic generator 212 leverages its pre-trained knowledge and/or pattern-recognition capabilities to generate regex examples. The prompt 211 provides instructions, such as specifying the parameters to extract (for example, source, destination, and date), while the URL patterns 210 serve as an example of the structural format the regex should generalize. Internally, the LLM analyzes the key-value structure of query strings and learns associations between parameter keys and corresponding values based on training data or eventually produces satisfactory outputs via prompt engineering. Using this understanding, it generates a regex sample 214 that can dynamically match and extract the required parameters. For example, given the prompt “Generate a regex to extract the source, destination, and date from the following URL pattern” and the pattern “https://flights.example.com/search?source={source}&destination={destination}&date={date},” the LLM outputs a regex like “source=(\w{3})&destination=(\w{3})&date=(\d{4}-\d{2}-\d{2}).” This output is flexible enough to handle various URL instances while preserving accuracy.

The validation module 216 validates the generated regexes 214 against test URL samples and stores the validated regexes in a repository 217 for future use. The inputs are regexes 214 and test URLs for validation (from the data source collector 208 or new samples). The outputs include validated regexes, tagged by domain/subdomain, stored in a database or repository, and/or validation reports indicating regex performance. For example, the validation module 216 runs each regex sample 214 on the test URLs to extract expected parameters (for example, source, destination, date, etc.) and compares the extracted values to pre-labeled ground truth values. If the regex consistently (for example, over a certain percentage) extracts the correct values across various test cases, it is marked as validated. The module generates a validation report summarizing performance metrics, such as accuracy and failure cases, to ensure robustness. Validated regexes are then tagged by domain or subdomain and stored in a centralized repository or database for future retrieval during online execution. Regexes that fail validation are flagged for refinement or prompt updates.

The data source detector 208 (for example, the data source detector 105 of FIG. 1) detects when a user accesses a particular (for example, travel-related) website and retrieves the corresponding regex for that domain in the repository 217. The inputs include live URL data 224, which includes live URL(s) accessed by the user in a browser or app, the domain or subdomain metadata of the URL, and/or validated regexes. Outputs include the live URL matched with the corresponding regex from 217 and extracted travel parameters (for example, source, destination, travel dates, etc.) (for example, from the online logic retrieval and application 106).

The backend API 220 (for example, the backend API 108 of FIG. 1) processes the extracted parameter(s) to retrieve alternative options or recommendations. For example, inputs to the backend API 220 may include travel parameters extracted by data source detector 218, and/or additional user preferences (for example, loyalty programs, preferred airlines/hotels, etc.). The outputs include, for example, alternative travel suggestions (for example, cheaper flights, better hotels, etc.). The output generator 222 (for example, the notification/output generator 114) generates the results (for example, alternative options or enhanced itineraries) to the user device in an accessible format. Outputs may include browser notifications (for example, “Cheaper flight available: $350”), pre-populated booking forms for travel sites, or enhanced itineraries with suggestions for tours, restaurants, etc.

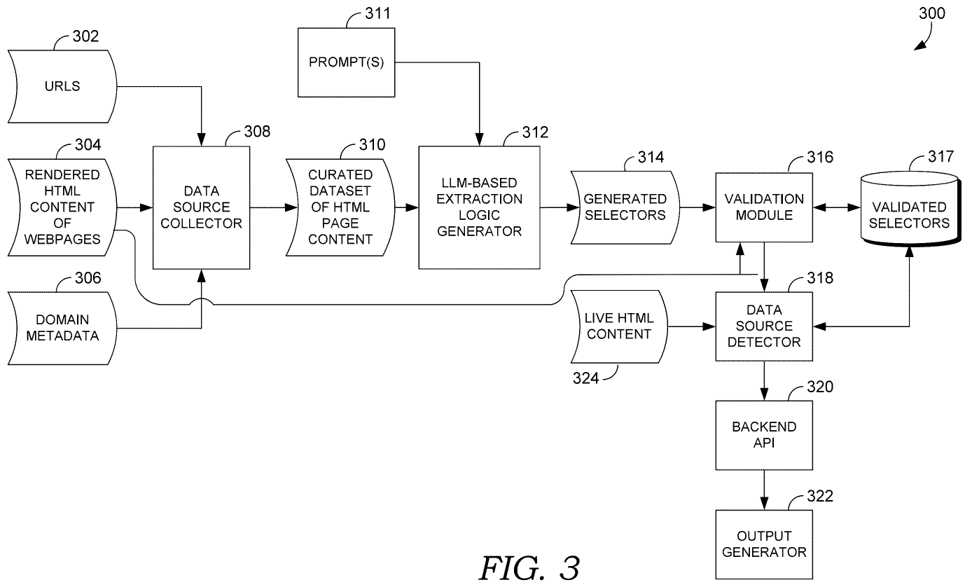

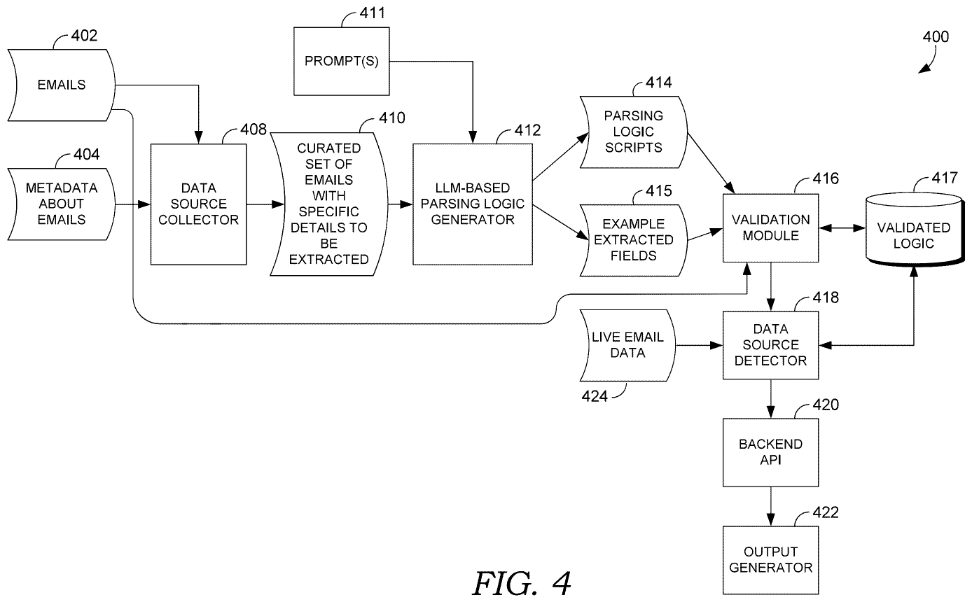

In some embodiments, the feedback loop module 112 of FIG. 1 is also incorporated into FIG. 2, FIG. 3, and/or FIG. 4. In these embodiments, the feedback loop module 112 receives input from the backend APIs 220, 320 and/or 420 to impact the prompts 211,212, 311, 312, 411, and/or 412 respectively. For example, if the system extracts a flight date as “2025-06-15”, but the API 220 returns an empty or mismatched result (for example, suggesting flights for “2024-06-15”), the feedback loop module 112 identifies the discrepancy and analyzes whether the issue stems from an incorrect date format, partial extraction, or missing context. The module 112 then modifies the prompt(s) 211 for the LLM-based extraction logic generator 212 by adding constraints or additional examples, such as specifying that “dates should always be extracted in YYYY-MM-DD format”. This refined prompt is then used to regenerate the extraction logic, ensuring future extractions align better with API expectations, improving accuracy and adaptability in real-time.

FIG. 3 illustrates a pipeline 300 for processing selectors'extraction logic from web or app sources, according to some embodiments. At a first time, a data source collector 308 takes, as input, URLs 302 (for example, URLs of travel-related domains [for example, collected via browser logs or predefined datasets]), rendered HTML content of webpages (for example, via a headless browser) 304, and domain metadata 306 (for example, flights, hotels, car rentals, etc.) to generate a curated dataset of HTML page content 310 (for example, with target pricing elements). In other words, the purpose is to gather HTML content (for example, from travel-related websites) for training or prompt engineering the LLM to generate selectors (for example, XPaths or CSS selectors).

For example, the data source collector 308 retrieves a rendered HTML using a headless browser (for example, Puppeteer or Selenium). The headless browser simulates user interactions and renders dynamic content (for example, flight prices, hotel details, etc.) that might not be visible in static HTML. The data source collector 308 inspects the DOM structure to identify and extract key elements (for example, div or span tags containing price or booking details) based on domain-specific metadata (for example, airline or hotel pages). The extracted HTML content is annotated with labels indicating the target elements (for example, prices or booking references), creating training/input-output example samples for the LLM. The result is a structured dataset of annotated HTML snippets (i.e., 310) categorized by domain or subdomain, enabling the LLM to generate accurate XPaths or CSS selectors for future extraction tasks.

The LLM-based extraction logic generator 312 takes, as input, the prompt(s) 311 and the curated dataset of HTML page content 310 to generate extraction logic (for example, XPaths, CSS selectors, etc.) tailored to specific information (for example, pricing elements on travel-related websites). The predefined prompt(s) 311, for example, specify the pricing details to extract (for example, lowest price, multiple pricing tiers, etc.). The LLM-based extraction logic generator 312 processes the inputs and generalizes patterns in the DOM structure by identifying consistent paths to the target elements, even when variations exist across pages. For instance, given a prompt like “Generate an XPath to extract the price from the following HTML structure” and a labeled sample, such as “<div class=”flight-result“><span class=”price“>$450</span></div>,” the LLM Outputs a General Xpath Expression Like “//div[@class=‘flight-result’]//span[@class=‘price’].” This ensures that the generated logic can adapt to various pages with similar structures while reliably locating the target data. The LLM-based extraction logic generator 312 recognizes patterns across multiple samples, such as consistent parent-child relationships, frequently used classes, or repeated element hierarchies, while noting variations in non-essential attributes (for example, differing sibling elements or dynamic IDs). Using this understanding, the logic generator 312 generalizes extraction paths by focusing on stable and frequently recurring structural features (for example, a specific div containing price information nested under a predictable parent).

The validation module (for example, the validation module 216 of FIG. 2) validates the generated selectors 314 against sample webpages and stores the validated selectors in the repository 317 for future use. Selectors (for example, XPath or CSS selectors) are validated by applying them to test HTML samples and verifying that they consistently locate and extract the correct target elements (for example, prices, dates, etc.) across varying page structures. The validation module 316 takes the generated selectors 314 and applies them to a set of labeled HTML test pages containing known target values. It then compares the extracted output to the expected values stored in the annotations. If the selector successfully extracts the correct values across diverse test samples without false positives or omissions, it is marked as validated. In some embodiments, the validation process also includes performance checks to ensure the selector is efficient and does not traverse unnecessary DOM elements. Failures are flagged for refinement, and validation reports document metrics like accuracy, recall, and false-positive rates before storing the validated selectors in a repository for runtime use.

The data source detector 318 (for example, the data source detector 105) detects when a user accesses a particular website (for example, travel-related) and retrieves the corresponding/matching selector for that domain in the repository 317 (for example, via semantic analyses or fuzzy matching). The data source detector 318 does so by monitoring the live HTML content 324 rendered in the browser and identifying the domain or subdomain (for example, flights. example. com). It retrieves the pre-generated selector (for example, XPath or CSS) from the repository 317 corresponding to the detected domain. The detector 318 then applies the selector to the live DOM structure of the webpage, extracting relevant information such as lowest prices, pricing tiers, and additional contextual details (for example, flight segments or room types). The extracted data is passed downstream to be processed or displayed as part of user recommendations via the backend API 320 (for example, backend API 220) and output generator 322 (for example, output generator 322). For example, the backend API 320 extracts pricing data to retrieve alternative travel options or identify cheaper/better choices by receiving pricing information extracted by data source detector 318 and travel parameters (for example, destination, dates, etc.) from other sources. The outputs include alternative options or recommendations, such as alternative travel options (for example, cheaper flights, better hotel rooms, etc.). The output generator 322 generates the results (for example, price comparisons or alternative suggestions) to the user in an accessible format. For example, the results can include browser notifications (for example, “Better hotel room available for $200”) or suggestions or overlays on the live webpage highlighting deals.

FIG. 4 illustrates a pipeline 400 for processing code extraction logic from emails, according to some embodiments. At a first time, the data source collector 408 takes, as input, the emails 402 (for example, travel booking emails, such as confirmation emails for flights, hotels, or car rentals) and the metadata about emails 402 to generate a curated set of emails with specific details to be extracted. For example, the metadata 404 may include metadata about the email sender's domain or subdomain (for example, “flights@airline.com”). In some embodiments, the output 410 includes a curated dataset of emails annotated with the specific details to be extracted (for example, flight numbers, dates, booking references, etc.).

In an illustrative example, the data source collector 408 generates a curated set of travel-related emails by collecting booking confirmation emails from various sources (for example, flights, hotels, or car rentals) and associating them with metadata about the sender's domain or subdomain (for example, flights@airline.com). Using email client APIs (for example, Gmail API or Microsoft Graph API), the data source collector 408 retrieves relevant emails and parses the body and headers to identify key fields, such as flight numbers, dates, and booking references. The emails are then annotated with labels marking the target details, creating structured training/prompt engineering examples for the LLM-based parsing logic generator 412 to generate parsing logic (for example, regexes or scripts). This curated dataset ensures that diverse formats and variations across different providers are captured for robust parsing logic generation.

In some embodiments, the emails 402 contain comprehensive travel itineraries, combining flight, hotel, and car rental reservations into a single structured email. In these embodiments, the system parses this email using language model generated scripts or executable code, extracting parameters for each booking category (flight, hotel, car rental). It detects structured keywords like “Flight,” “Hotel,” and “Car Rental” to segment the extracted data and apply domain-specific extraction logic. The extracted details are then passed to APIs for alternative recommendations, such as cheaper flights, hotel upgrades, or rental car discounts, ensuring a comprehensive and context-aware travel experience.

The LLM-based parsing logic generator 412 takes, as input, the prompt(s) 411 and curated set of emails with specific details to be extracted 410 to generate parsing logic scripts 414 tailored to extract travel-related details from emails, such as parsing scripts (for example, Python or Perl scripts) for extracting relevant travel information. Another output of the generator 412 may include example extracted fields (for example, departure time: 10:00 AM, flight number: XYZ123) for validation. The annotated dataset provides the LLM-based parsing logic generator 412 with examples of key fields (for example, flight numbers, booking references, etc.) and their surrounding context within the email content. The prompt(s) 411 specifies instructions, such as “Generate a Python script to extract flight details, dates, and booking references from emails with this structure.” The LLM processes the email structure, identifies patterns (for example, keywords like “Flight Number” or “Departure Time”), and outputs a parsing logic script that includes regexes or pattern-matching functions. Alongside the script, the LLM generates example outputs (for example, flight_number =“XYZ123”) to ensure proper validation before deployment.

The validation module 416 validates the generated parsing logic 414 against a test set of emails and stores the validated logic in the repository 417 for future use. The outputs include validated parsing logic scripts, tagged by email domain or subdomain, stored in a repository, and/or validation reports indicating parsing accuracy (optional). The parsing logic 414 is validated by applying the generated script to a set of test emails from the curated dataset 410 and comparing the extracted fields (for example, flight numbers, booking references, etc.) to the ground truth annotations. For each test email, the validation module 416 checks whether the parsing logic correctly identifies the expected fields without errors or missing values. In some embodiments, performance metrics like precision, recall, and/or accuracy are calculated to ensure robustness. For example, if the parsing logic correctly extracts the flight number “XYZ123” from emails with varying formats, it passes validation; otherwise, errors are logged, and the script is refined or retrained.

The data source detector 418 detects when a user receives or opens an email (for example, travel-related) and retrieves the corresponding parsing logic for the sender's domain. Inputs include live email data 424, such as new emails arriving in the user's email client (for example, Outlook, Gmail, etc.), email domain or subdomain metadata (for example, “confirmation@hotel.com”), and/or parsing logic scripts from the repository 417. The outputs are extracted parameter(s), such as extracted travel booking details (for example, flight numbers, hotel check-in times, car rental details, etc.).

The backend API 420 uses extracted parameter(s) to generate tailored recommendations or additional options. In some embodiments, the inputs to the API 420 include travel details extracted by the data source detector 418 and/or user preferences (for example, loyalty programs, travel history, etc.). The output of the API 420 may include, for example, tailored suggestions (for example, rental cars for a flight, nearby attractions for a hotel stay, etc.), and/or enhanced itineraries pre-populated with extracted travel details.

The output generator 422 generates extracted information from the data source detector 418 and/or additional suggestions/options (from the backend API 420) to the user device in an accessible format. For example, the outputs can include travel cards summarizing booking details (for example, “Flight XYZ123, Jan 23, 10:00 AM”), pre-populated booking options (for example, car rental pickup at airport arrival time), and/or notifications (for example, “Check-in available for your flight”).

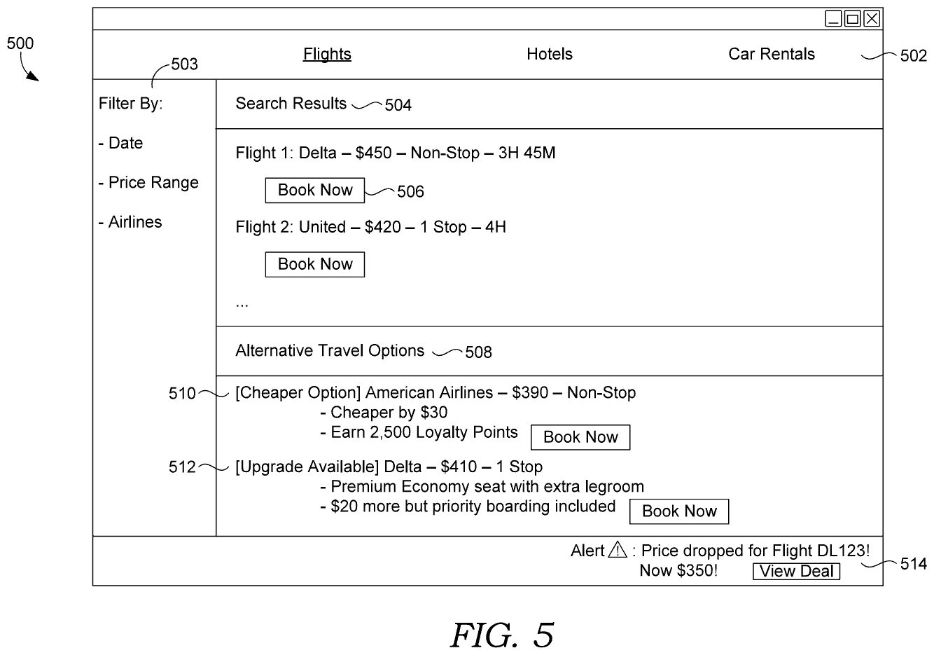

FIG. 5 is a screenshot representing an example user interface page 500, according to some embodiments. The user interface page 500 illustrates an interactive travel booking interface that displays extracted travel details from URLs and webpages, such as flight options, prices, and itineraries. The user interface page 500 includes a navigation bar 502. The navigation bar is a fixed UI element positioned at the top of the page 500 that allows users to navigate between different travel categories—Flights, Hotels, and Car Rentals. It provides a consistent and accessible menu for switching between various search contexts, ensuring a seamless user experience. The navigation bar contains clickable tabs or buttons labeled with each category, which trigger content updates in the Search Results Panel and Recommendation Section based on the selected travel type. It also includes contextual indicators (for example, an underline or color change) to highlight the active category, maintaining user awareness of their current selection. The user interface page further includes search results 504, alternative travel options 508, a filter panel 503, and a notification 514. In some embodiments, the alternative travel options 508 represent the “alternative option” as described herein.

In an illustrative example, the user navigates to flights.example.com by clicking on the “Flights” link in the navigation bar 502 to search for flights. Responsively, the data source detector 105 detects the URL, and the system retrieves the XPath from storage 117 to extract flight details. That is, when the user clicks on the “Flights” tab in the navigation bar 502, the system detects the URL change as they are redirected to flights.example.com, signaling that the user is searching for flights, which triggers the data source detection and initiates the extraction logic retrieval for this specific domain. Responsively, the Search Results Panel 504 displays the extracted prices and itineraries. The extracted prices are sent to the backend API 108, which finds a cheaper alternative and displays it in the alternative travel options 508.

The filter 503 on the page 500 allows users to refine and customize their search results by specifying date, price range, and preferred airlines. These filters are displayed in a sidebar next to the Search Results Panel and include interactive elements such as date pickers, sliders for price range, and checkboxes for airlines. When a user adjusts a filter (for example, selecting a travel date or setting a maximum price), the UI dynamically updates the displayed search results by sending the selected parameters to the backend API 108, which re-queries the extracted data and returns results matching the filter criteria. This ensures that users see only relevant travel options that fit their preferences, enhancing usability and decision-making efficiency.

The floating notification widget 515 at the bottom-right corner of the page 500 is a real-time alert system that provides users with contextual notifications about important updates, such as price drops, better travel deals, or alternative recommendations. In some embodiments, it appears as a small, fixed overlay that floats above the main content without interrupting the user's browsing experience. When the system detects a significant change or change over a predefined threshold (for example, a cheaper flight option), the widget 515 displays a concise message (for example, “Price dropped for Flight DL123! Now $350!”) with a call-to-action button (for example, “View Deal”). Clicking the button scrolls to or highlights the recommended option in the sections 504 or 508, allowing users to immediately explore and act on the update. In some embodiments, the widget 515 auto-dismisses after a few seconds or can be manually closed, ensuring non-intrusive, yet actionable notifications.

Continuing with FIG. 5, the “Book Now” buttons (for example, button 506) are call-to-action elements located on each travel card (search result) within the Search Results Panel 504 and Alternative Travel Options Panel 508, enabling users to directly initiate the booking process for a selected travel option. Responsive to receiving an indication that a user has clicked the “Book Now” button, the UI passes the extracted parameters (for example, flight number, price, departure time, etc.) to the backend API 108, which then redirects the user to the external booking platform or opens a pre-populated booking form within the page 500. These buttons are strategically placed to encourage quick decision-making and streamline the booking experience, minimizing the number of steps required to complete a purchase. In some embodiments, the alternative travel options 510 and 512 are not displayed or determined if and until receiving an indication that the user has selected the “Book Now” button so as to compute alternative travel options.

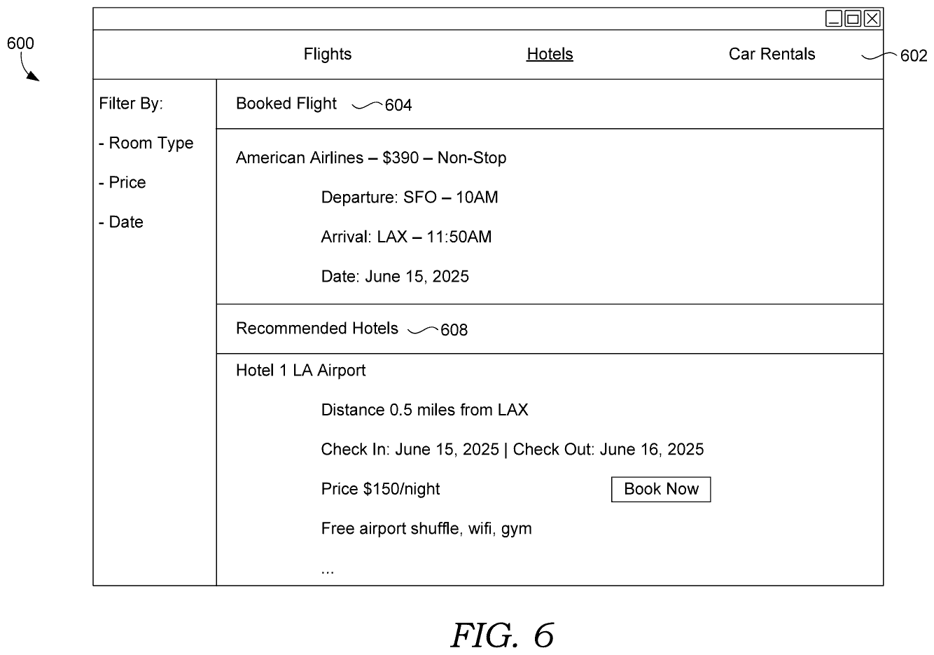

FIG. 6 is a screenshot representing an example user interface page 600, according to some embodiments. FIG. 6 illustrates a contextual travel booking experience by displaying recommended hotels that are consistent with the user's booked flight details, such as arrival location and travel dates. It automatically aligns check-in and check-out dates with the flight itinerary and prioritizes hotels near the destination airport, ensuring convenience and relevance. This design enhances the user's travel planning by seamlessly integrating flight and accommodation bookings into a unified, personalized flow.

In response to receiving an indication that a user has selected a button or other user interface element (for example, the “book now” button in 510 or the “Hotels” link in the navigation bar 502 of FIG. 5), particular embodiments cause display of the booked flight as indicated in 604. Simultaneously, particular embodiments call the backend API 108 (and/or a second backend API different than the backend API described in FIG. 5) to retrieve recommended hotels as indicated in 608. Recommended hotels (and/or recommended cars for car rentals) represent a “recommendation” (for example, “travel recommendation”) as described herein.

Recommended hotels are presented to the user by leveraging the extracted parameters from the booked flight, such as arrival location, travel date, and/or time. The system detects the booked flight information through the data source detector 105 when the user completes a flight booking or accesses a flight confirmation page. The system then retrieves relevant extraction logic from the repository 105 to accurately extract parameters (for example, via the online logic retrieval and application 106) like destination, arrival date, and departure time. These parameters are provided to the backend API 108, which queries one or more hotel databases for accommodations near the arrival airport, ensuring that check-in and check-out dates are consistent with the flight itinerary. The recommended hotels section 608 displays the suggested hotels, highlighting proximity to the airport, availability, and pricing, while in some embodiments a floating notification widget may alert users to special offers or loyalty program benefits, providing a personalized and seamless travel booking experience.

In some embodiments, the recommended hotels section 608 can alternatively or additionally represent recommended car rentals. For recommending car rentals, some embodiments extract parameters from the booked flight—including arrival airport, arrival time, and travel dates—using the data source detector 105 and retrieved extraction logic. Once the flight details are detected, the parameters are sent to the backend API 108, which queries car rental databases for available vehicles at the arrival airport. The system ensures that the pickup date and time are aligned with the flight's arrival date and time, and the return date is set to match the departure date. The Recommendation Section presents relevant car rental options, highlighting proximity to the arrival terminal, vehicle types, and/or pricing. Additionally, a floating notification widget can notify users of special discounts or loyalty program offers, ensuring the suggested car rentals are consistent with the flight itinerary and are personalized to user preferences. In some embodiments, the recommended hotels section 608 can alternatively or additionally represent recommended suggested travel itinerary items such as experiences, restaurants, tours, etc.

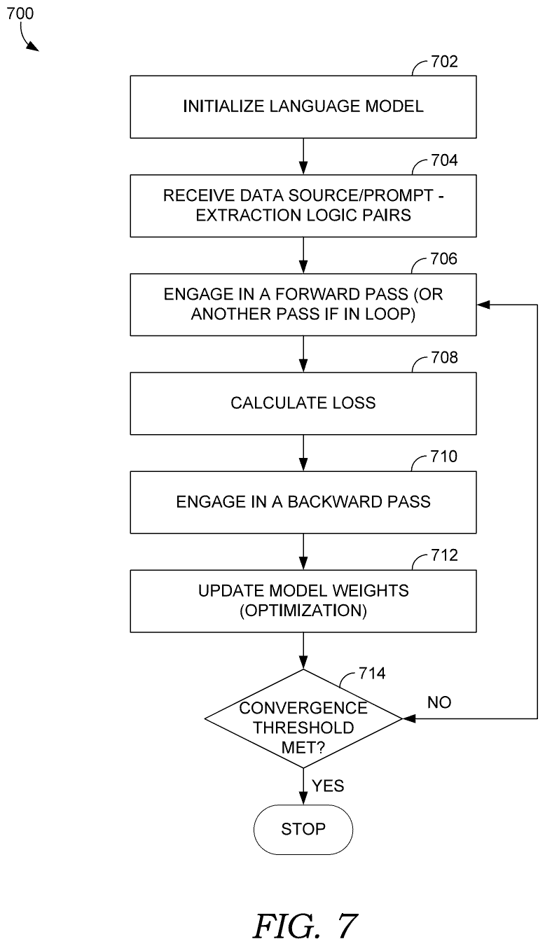

FIG. 7 is a flow diagram of an example process 700 for tuning (for example, train by prompt-tuning or fine-tuning) a language model to generate extraction logic, according to some embodiments. Prompt-tuning and fine-tuning are techniques used to adapt a language model to generate specific outputs (extraction logic) based on particular inputs. This training approach involves using supervised learning techniques with input-output pairs, where the input represents data sources (for example, URLs, HTML pages, and/or email) and the output represents generated extraction logic (for example, regexes, XPaths, or scripts). The model learns from these examples using gradient-based optimization, and the training loop iterates until convergence is achieved.

The process 700 (and/or any of the functionalities described herein such as 800 and 900) is performed by processing logic that comprises hardware (for example, circuitry, dedicated logic, programmable logic, microcode, and the like), software (for example, instructions run on a processor to perform hardware simulation), firmware, or a combination thereof. Although particular blocks described in this disclosure are referenced in a particular order at a particular quantity, it is understood that any block can occur substantially parallel with or before or after any other block. Further, more (or fewer) blocks can exist than illustrated. Added blocks can include blocks that embody any functionality described herein (for example, as described with respect to FIG. 11). The computer-implemented method, the system (that includes at least one processor and at least one computer-readable storage medium), and/or the computer-readable medium as described herein can perform or be caused to perform the process 700 or any other functionality described herein.

It is understood that although FIG. 7 describes tuning, the language model need not be tuned. For example, in some embodiments the language model is a pre-trained model that has been prompt-engineered without tuning. Prompt engineering is the practice of designing and optimizing input prompts to guide a pre-trained language model's behavior and output without modifying the model's underlying parameters (for example, changing weights and biases). It involves carefully crafting questions, instructions, or prompt context to achieve the desired output, such as specifying the format or structure of the extraction logic. In contrast, fine-tuning involves updating the model's weights using a domain-specific dataset through additional training. It adjusts the model's internal parameters to better adapt to a specialized task, such as generating regexes or XPaths for data extraction. While prompt engineering relies on input manipulation to leverage a pre-trained model's existing capabilities, fine-tuning modifies the model itself for improved performance on a targeted task.

Per block 702, some embodiments initialize a language model (for example, GPT, T5, etc.) with necessary hyperparameters such as learning rate, batch size, and maximum sequence length. For example, particular embodiments receive user input specifying a GPT model, where layers=12, hidden size=768, attention heads=12, learning rate=0.0001, batch size=32, max sequence length=512, optimizer=AdamW, and loss function=Cross-Entropy Loss.

Per block 704, some embodiments receive or collect data source/prompt extraction logic pairs, which represent the training data ground truth. In other words, a dataset of input-output pairs are generated where the input represents different data sources and/or prompts. The output of the input prompt pairs represents the expected output, which is a properly structured and actionable extraction logic. These examples are used to guide the language model to perform text generation to generate the correct extraction logic.

For example, a data source to an extraction logic pair may be: “https://travel.example.com/search?source=SFO&destination=LAX&date=2025-06-15” (input), and the output may be “source=(\w{3})&destination=(\w{3})&date=(\d{4}-\d{2}-\d{2}).” An example of a prompt to an extraction logic pair is as follows: input =“Generate a regex to extract source, destination, and date from the URL pattern.” The output=“source=(\w{3})&destination=(\w{3})&date=(\d{4}-\d{2}-\d{2}).” Using both data source extraction logic and prompt-extraction logic pairs ensures that the model learns both contextual pattern recognition and task-specific instruction following. After receiving the input-output pairs, some embodiments convert the input-output pairs into tokenized sequences compatible with the LLM's vocabulary. The tokenizer encodes both the input and the expected output as sequences of tokens for model processing.

Per block 706, some embodiments engage in a forward pass (or another pass if in a loop [for example, a “no” decision at block 714]). For each input-output pair, some embodiments feed the input (for example, the data source and/or prompt) into the language model. The model processes the input and generates an initial output, which is a candidate output extraction logic. The goal is to generate a first version of the extraction logic that reflects the command in the prompt or the correct data source used. The model generates text output (extraction logic) based on its understanding of the input. For example, where the language model is an LLM, during a forward pass, the model processes the input sequence by passing it through each layer of the transformer architecture, including an embedding layer, multi-head self-attention layers, feedforward layers, and an output layer. The input sequence is first tokenized and embedded into continuous vector representations (numbers representing the tokens). These embeddings are then passed through multi-head self-attention layers, where the model calculates attention scores to capture contextual dependencies between tokens. The outputs of the attention layers are then fed into feedforward neural networks for further transformation and non-linearity. The final layer generates logits (raw predictions) corresponding to the vocabulary tokens, representing the model's predictions for the next token in the sequence. These logits are used in the loss calculation step to compare with the ground truth output.

The predictions of the next token in the sequence correspond to individual components of the extraction logic (for example, regex patterns or XPath selectors). If the input is “https://travel.example.com/search?source={source}&destination={destination}&date={date},” for example, and the output is a regex to extract the query parameters, the model predicts tokens for each part of the pattern sequentially. For instance, given the partially generated output “source=(\w{3})&destination=,” the model predicts the next token as (\w{3}), recognizing the pattern for a 3-letter destination code. The next predicted token could be “&date=” followed by “(\d{4}-\d{2}-\d{2})” to match the date format (YYYY-MM-DD). The complete output becomes: “source=(\w{3})&destination=(\w{3})&date=(\d{4}-\d{2}-\d{2}).” The model sequentially predicts each token by considering the preceding context and the patterns learned during training, ensuring that the generated extraction logic accurately matches the input data structure.

Per block 708, some embodiments calculate a loss. In other words, particular embodiments compare the language model-generated extraction logic prediction to the expected or ground truth extraction logic (the ground truth from the training data output) using a loss function, such as Cross-Entropy Loss, for language tasks. The goal is to measure how well the generated extraction logic matches the target extraction logic. The Cross-Entropy Loss calculates the difference between the probabilities assigned to the words in the generated extraction logic versus the expected extraction logic. In other words, particular embodiments calculate the Cross-Entropy Loss between the predicted tokens and the ground truth output tokens. A higher loss indicates a greater mismatch, while a lower loss means the generated prompt is close to the target.

Per block 710, some embodiments engage in a backward pass (for example, via Gradient Descent). In other words, various embodiments perform a backward pass through the language model to calculate the gradients of the loss with respect to the model's parameters. This involves computing the gradients for each layer of the model based on the error (loss) calculated at block 708. The goal is to determine how the model's weights should be updated to reduce the error in future iterations. Gradients help the model understand how much to adjust its parameters (weights) in order to generate better outputs in the next iteration.

Per block 712, some embodiments update model weights for optimization. To do this, some embodiments use an optimization algorithm, such as Stochastic Gradient Descent (SGD) or Adam, to update the model's weights based on the gradients calculated at block 710. The goal is to iteratively improve the model's ability to generate accurate prompts by reducing the loss over time. The optimizer adjusts the model parameters slightly with each iteration, aiming to minimize the overall loss and make the model's predictions closer to the target outputs. For example, after adjusting the weights, the next iteration should generate a more precise extraction logic.

Per block 714, some embodiments determine whether a convergence threshold has been met. Various embodiments stop the training process 700 when a convergence threshold is reached, either based on a predefined convergence threshold (for example, when the loss falls below a certain value) and/or after a set number of iterations (epochs). The goal is to end training when the language model consistently generates accurate extraction logic that aligns with the expected target/ground truth outputs.

The stopping criteria can also involve checking validation data to ensure the model generalizes well beyond the training set. For example, training stops when the Cross-Entropy Loss is below 0.01, indicating that the model is consistently producing highly accurate prompts. If the convergence threshold has not been met (for example, a “no” decision at block 714), then particular embodiments engage in blocks 706 (for example, another pass), 708, 710, 712, and 714 (and/or new input-output pairs are received at block 704). In other words, these steps are repeated for multiple input-output pairs in the training dataset. The model iteratively processes inputs, computes loss, updates its weights, and refines its outputs over time. The goal is to iteratively improve the model's performance, minimizing the loss with each step and making the language model more effective at generating extraction logic based on the input data sources and/or prompts. The training loop continues until the model reaches a satisfactory level of performance.

After training, some embodiments evaluate the language model on a separate test set that includes unseen input-output pairs. The goal is to verify that the model can generalize to new data and generate accurate extraction logic when given new prompts and/or data sources. This step ensures that the language model performs well in real-world scenarios, not just on the training data.

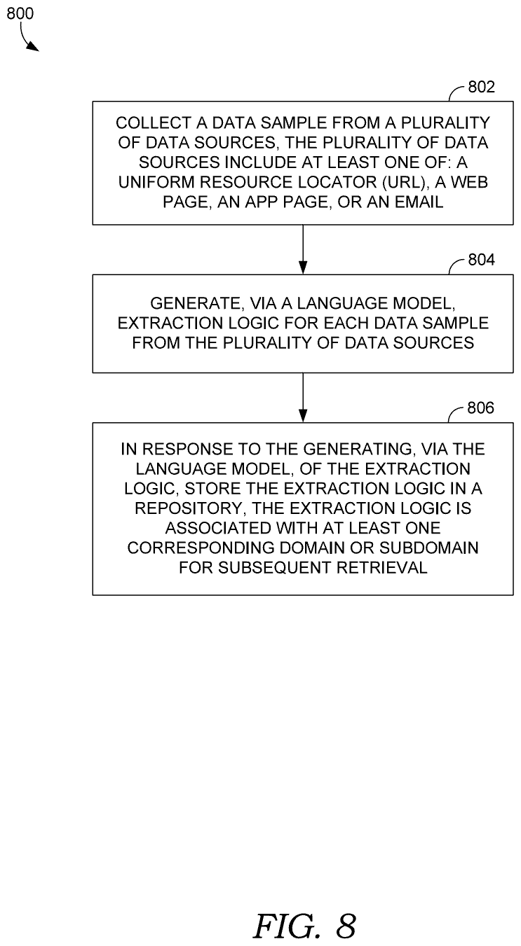

FIG. 8 is a flow diagram of an example process for generating and storing extraction logic offline in preparation for processing data during a future runtime process, according to some embodiments. Per block 802, some embodiments first collect a data sample from a plurality of data sources, where the plurality of data sources include at least one of: a Uniform Resource Locator (URL), a webpage, an app page, or an email. For example, the data source collector 102 aggregates data samples from a variety of sources, including URLs, webpages, app pages, and emails, to create a comprehensive training dataset. In some embodiments, it uses web scraping tools (for example, Puppeteer or Selenium) to collect URLs and rendered HTML content from travel-related domains and app pages by simulating user interactions. For emails, in some embodiments it leverages email client APIs (for example, Gmail API or Microsoft Graph API) to access and retrieve booking confirmation emails. In some embodiments, the collector tags each data sample with metadata such as source type (URL, webpage, app page, or email), domain, and subdomain, ensuring the samples are properly categorized for subsequent extraction logic generation.

Per block 804, some embodiments generate, via a language model, extraction logic for each data sample from the plurality of data sources. In some of these embodiments a sample and/or a prompt as described herein represents the input fed to the language model. For example, an LLM generates extraction logic (for example, regex, XPath, or CSS selectors) by processing each data sample from the collected dataset (and/or based on previously performing the process 700 to train on a training dataset). First, the data sample (for example, a URL, HTML snippet, or email content) is tokenized into sequences of tokens representing words, symbols, or structural elements. These tokens are then embedded into high-dimensional vectors, capturing the semantic and syntactic relationships between them. The model uses multi-head self-attention mechanisms to calculate the relevance of each token to every other token in the sequence, allowing it to identify contextual dependencies and patterns within the data sample. Using this contextual understanding, and identical to a forward pass as indicated in block 706 of the process 700, the LLM generates a sequence of tokens corresponding to the extraction logic, such as a regex pattern or an XPath selector. The model then outputs the extraction logic as a complete sequence, ensuring that it accurately matches the target elements within the data sample while maintaining flexibility to adapt to similar patterns across different data sources.

In some embodiments, the data source includes the URL and the extraction logic includes a regular expression (regex) so that the operations at block 802 include collecting a plurality of URLs from logs of browsers from a plurality of domains, the URL being included in the plurality of URLs, and the language model generates, at block 804, the regex based on processing the plurality of URLs. For example, the Large Language Model (LLM) generates a regex by first processing the plurality of URLs collected from browser logs across multiple domains. The URLs are tokenized into individual components, such as protocol, domain, path, and query parameters. These tokens are then embedded into vectors that capture the semantic relationships and structural patterns present across the URLs. The model uses multi-head self-attention to identify consistent patterns in the query parameters (for example, source=SFO, destination=LAX, and date=2025-06-15) while recognizing variations in parameter names or value formats. By learning these structural patterns and variations, the LLM generalizes the extraction logic into a flexible regex that can match similar URLs across different domains. For example, the model generates a regex like source=(\w{3})&destination=(\w{3})&date=(\d{4}-\d{2}-\d{2}), which accurately captures the query parameters while allowing for different values.

In some embodiments, the data source includes the webpage and the extraction logic includes at least one of an Extensible Markup Language Path (XPath) selector or a Cascading Style Sheets (CSS) selector. In this way, the collecting at block 802 includes collecting HyperText Markup Language (HTML) page content of a plurality of websites, where the webpage is included in the HTML page content, and where the language model generates the XPath selector or CSS selector based on processing the HTML page content of a plurality of websites. For example, an LLM generates an XPath or CSS selector by processing the HTML page content collected from a plurality of websites. The model first tokenizes the HTML content into DOM elements, tags, attributes (for example, class, ID, etc.), and text nodes. These tokens are embedded into vectors that capture the hierarchical structure and semantic relationships within the DOM tree. Using multi-head self-attention, the model identifies consistent patterns and structural paths leading to the target elements (for example, prices, booking details, etc.) across different HTML layouts. It recognizes reliable identifiers (for example, consistent class names or nested tag structures) while generalizing the pattern to account for layout variations across websites. The LLM then generates an XPath or CSS selector that accurately navigates the DOM tree to extract the target parameter. For example, the model produces an XPath like “//div[@class=‘flight-result’]//span[@class=‘price’]” or a CSS selector like “. flight-result. price,” ensuring the extraction logic is flexible yet precise for a variety of webpage structures.

In some embodiments, the data source includes the email and the extraction logic includes computer programming code, such that the collecting at block 802 includes collecting a plurality of emails from a domain, where the language model generates the computer program code based on processing the plurality of emails. For example, an LLM generates computer programming code (for example, Python or JavaScript) for extracting parameters from emails by first processing a plurality of emails collected from a specific domain. The emails are tokenized into components such as headers, subject lines, body text, and HTML tags, capturing both the textual content and structural patterns. These tokens are then embedded into vectors that represent the contextual relationships between different parts of the email (for example, recognizing that a flight number typically follows a phrase like “Your flight number is:”). Using multi-head self-attention, the model identifies consistent patterns in how target parameters (for example, flight numbers, booking references, etc.) are presented across different email formats. It generalizes these patterns to generate programmatic extraction logic, such as regexes or string parsing functions, embedded within a larger script structure. The model then outputs complete computer programming code (for example, a Python function using regex or a JavaScript DOM parser) that efficiently navigates the email structure and extracts the desired parameters. This code is designed to be robust and reusable across similar emails from the same domain.

Continuing with this email functionality, some embodiments compile or interpret the computer programming code and associate the computer programming code with the domain, and then confirm that the computer programming code consistently extracts correct parameters by validating the compiled or interpreted computer programming code against at least a second email. In this use case, some embodiments compile or interpret the generated computer programming code (for example, Python scripts or JavaScript functions) and associates it with the domain from which the emails were collected. First, for example, the system compiles the code into an executable format (for example, bytecode for Python) or interprets it within a runtime environment (for example, Node.js for JavaScript). In some embodiments, the compiled or interpreted code is then tagged with metadata identifying the corresponding domain (for example, flights@airline.com), ensuring that the extraction logic is domain-specific. This association is stored in an extraction logic repository, allowing the system to retrieve and apply the code to emails from the same domain during runtime.

To validate the extraction logic, some embodiments apply the compiled or interpreted code to at least a second email from the same domain. It extracts the target parameters (for example, flight numbers, booking references, etc.) and compares the extracted values against the expected ground truth labels. If the extracted parameters consistently match (for example, over a particular quantity threshold) the expected values across multiple test emails, the code is marked as validated. In some embodiments, performance metrics such as accuracy, precision, and recall are calculated to ensure the extraction logic is robust and reliable. If validation fails, the system refines the extraction logic by adjusting the prompt or retraining the LLM. Once validated, the code is stored in the repository and tagged for future retrieval, ensuring consistent parameter extraction for similar emails from the same domain.

In an illustrative example of validation, if the generated code is a Python script designed to extract a flight number from emails sent by flights@airline.com, some embodiments first compile the script and tag it with the domain identifier. It then applies the compiled script to a second email from the same domain, which contains the text: “Your flight number is: XYZ123.”The script uses a regex pattern like “Flight number is: (\w{6})” to extract XYZ123. The system compares this extracted value to the expected output (XYZ123) from the ground truth labels. If the extracted value matches the expected output, the validation is successful. The system then repeats this process with additional emails from the same domain to ensure consistency. If all test cases pass, the script is marked as validated and stored in the repository at block 806 for runtime use. If the script fails to extract the value or produces incorrect results, it is refined and revalidated until it consistently achieves accurate extraction.

Per block 806, in response to the generation, via the language model, of the extraction logic, some embodiments store the extraction logic in a repository, where the extraction logic is associated with at least one corresponding domain or subdomain for subsequent retrieval. In other words, the extraction logic (for example, regexes, XPaths, or scripts) is stored in a centralized repository, which may be implemented as a relational database or a NoSQL document store. In some embodiments, each piece of extraction logic is tagged with metadata that includes the corresponding domain or subdomain (for example, flights.example.com or hotels.example.com), ensuring domain-specific retrieval. Some embodiments associate the extraction logic with the domain by extracting the domain or subdomain from the data source URL or email header and storing it as a key-value pair (for example, of a hash map or lookup structure) alongside the extraction logic. The key is the domain or subdomain (for example, “flights.example.com”), and the value is the extraction logic (for example, the regex pattern or XPath) associated with that domain, ensuring domain-specific retrieval during runtime. Additionally, metadata such as data type (URL, HTML, or email), creation timestamp, and/or validation status are stored in some embodiments to facilitate efficient indexing and retrieval during runtime. This structured storage ensures that the extraction logic is easily accessible and reusable when the same or similar domain is detected during online execution.

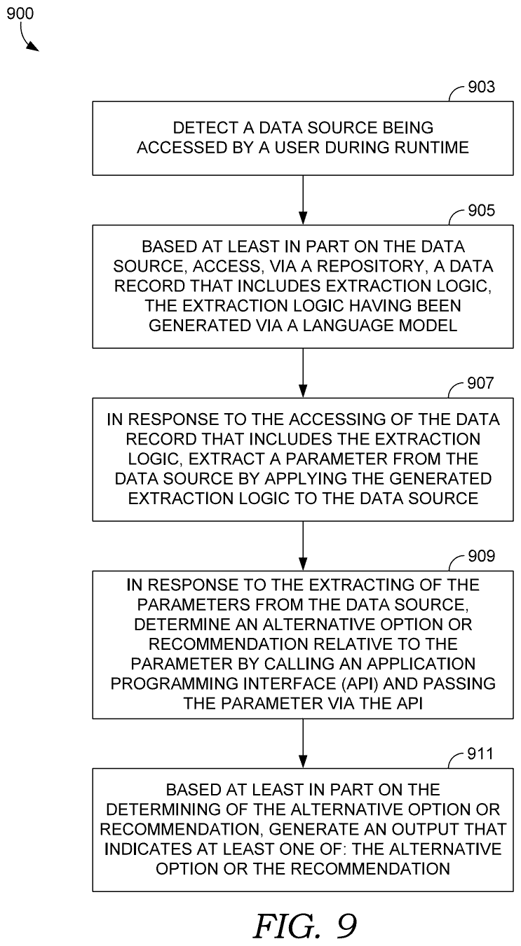

FIG. 9 is a flow diagram of an example process 900 for extracting a parameter from a data source and determining an alternative option or recommendation during runtime, according to some embodiments. Per block 903, some embodiments detect a data source being accessed by a user during runtime. For example, the data source detector 105 monitors user interactions using event listeners and network request interceptors. For URLs and webpages, it utilizes browser APIs (for example, Chrome's Web Navigation API or Service Workers) to detect navigation events or HTTP requests, capturing the URL and checking the domain or subdomain in some embodiments. For app pages, the data source detector 105 listens to in-app navigation events using deep link interceptors or universal links in some embodiments. For emails, it integrates with email client APIs (for example, Gmail API or Microsoft Graph API) to detect incoming messages or when the user opens an email in some embodiments. In some embodiments, block 903 alternatively or additionally represents obtaining the data source (for example, after it has already been detected). Obtaining can mean actively retrieving (for example, scraping a webpage or accessing an email through an API after a user has already accessed it) and/or passively monitoring (for example, detecting user navigation events).

In some embodiments, all the information described in the process 900 of FIG. 9 represents travel-related information (for example, as described with respect to FIG. 5 and FIG. 6). For example, the data source represents travel-related information, where the parameter includes at least one of: source and destination locations (for example, SFO to LAX), travel dates (for example, Feb. 21, 2025 arrival and Feb. 26, 2025 departure), pricing information (for example, $350 for a round-trip flight), or booking details (for example, confirmation number XYZ123), and wherein the alternative option or recommendation includes at least one of: an alternative travel suggestion (for example, a cheaper flight or a different airline), a price comparison (for example, comparing multiple booking sites for the best rate), or an additional travel-related recommendation (for example, a hotel near the destination or a car rental), and the output includes at least one of: a notification of the alternative travel suggestion (for example, “Cheaper flight available for $320”), a pre-populated booking suggestion (for example, filling in passenger details and dates), or an enhanced travel itinerary including a suggested experience or service (for example, recommended tours, restaurants, or airport lounge access).

Per block 905, based at least in part on the data source (and/or in response to detecting the data source), some embodiments access, via a repository, a data record that includes extraction logic, the extraction logic having been generated via a language model. During runtime, for example, some embodiments access the extraction logic by querying the repository for a data record that corresponds to the detected domain or subdomain. In some embodiments, when the data source detector 105 identifies a data source (for example, https://flights.example.com/search), it extracts the domain or subdomain (flights.example.com) and uses it as a key to query the repository (for example, implemented as a hash map or lookup structure). Offline, such as in the process 800 of FIG. 8, the extraction logic is stored as a key-value pair in some embodiments where the key is the domain or subdomain, and the value is the extraction logic (for example, a regex pattern or XPath) associated with that domain. The data record is also tagged with metadata including the data type (URL, HTML, or email), creation timestamp, and validation status, enabling efficient indexing and domain-specific retrieval. During the query, the repository looks up the key and returns the corresponding extraction logic, which is then applied to the live data source for accurate parameter extraction. This domain-specific association ensures the extraction logic is reusable and accurate for similar patterns across different data sources during online execution.

Per block 907, in response to the accessing of the data record that includes the extraction logic, some embodiments extract a parameter from the data source by applying the generated extraction logic to the data source. For instance, where the extraction logic is a regex, some embodiments match, via the regular expression (regex), a key in the regex to a key in the URL, and responsively extract a value representing the parameter in the URL. For example, if the URL is “https://flights.example.com/search?source=SFO&destination=LAX&date=2025-06-15,” some embodiments use a regular expression (regex) stored in the repository as “source=(\w{3})&destination=(\w{3})&date=(\d{4}-\d{2}-\d{2}).” During runtime, aspects detect the domain (flights.example.com) and retrieve the corresponding regex from the repository. The regex matches the keys (source, destination, and date) in the URL by identifying their positions and patterns within the query string. Specifically, it matches source=followed by a 3-letter code (SFO), destination=followed by another 3-letter code (LAX), and date=followed by a date pattern (2025-06-15). The regex captures the values associated with each key using capture groups—(\w{3}) for 3-letter codes and (\d{4}-\d{2}-\d{2}) for the date format. These captured values are then extracted as parameters, such as: source =“SFO”; destination =“LAX”; and date=“2025-06-15.” This parameter extraction is then provided to the backend API at block 909 for generating travel-related recommendations, ensuring accurate and context-aware processing of URL parameters.

Some embodiments additionally or alternatively apply the extraction logic to the data source by specifying a path or rule, via an Extensible Markup Language Path (XPath) selector or a Cascading Style Sheets (CSS) selector, for navigating through the webpage's Document Object Model (DOM) tree and locating a node containing the parameter. For example, if the webpage is an airline booking site with the HTML structure:
<div class=“flight-result”>
   <span class=“price”>$350</span>
</div>
   some embodiments use an XPath selector stored in the repository as “//div[@class=‘flight-result’]//span[@class=‘price’]” or a CSS selector as “.flight-result.price.” During runtime, the data source detector 105 identifies the webpage's domain (for example, flights.example.com) and retrieves the corresponding XPath or CSS selector from the repository. Some embodiments then apply the selector to the Document Object Model (DOM) tree of the webpage, navigating through the nested elements to locate the target node containing the parameter. In this case, the selector traverses the DOM to find the div element with the class flight result and then drills down to the span child node with the class price. It extracts the text content ($350), which represents the price parameter. The extracted price is then passed to the backend API at block 909 for comparison or recommendation generation. This approach ensures accurate and flexible extraction by leveraging the structural consistency of the DOM tree across similar pages.

Additionally or alternatively, some embodiments apply the extraction logic to the data source by scanning, using a custom script, content in the email for a predetermined field representing the parameter by identifying a key character in the script that corresponds to a key character in the email and extracting a value associated with the parameter using a defined pattern. For example, if the email contains the content: “Your flight number is: XYZ123,” then some embodiments use a custom Python script stored in the repository with the extraction logic:
pattern =r“Flight Number is: (\w{6})”
flight_number=re.search(pattern, email_content).group(1).

During runtime, the data source detector 105 identifies the email's domain (for example, flights@airline.com) and retrieves the corresponding custom script from the repository. The script scans the email content by matching a key character in the pattern (flight number is:) to the same key character in the email body. It then uses a defined pattern (for example, (\w{6})) to extract the value (for example, XYZ123) associated with the flight number parameter. The pattern \w{6} matches exactly six alphanumeric characters, ensuring accuracy. The extracted value is then stored as a parameter and can be used for itinerary management or travel notifications. This approach ensures consistent and accurate extraction by matching predefined keywords and patterns specific to the email's domain structure.

Per block 909, in response to the extracting of the parameters from the data source, some embodiments determine an alternative option or recommendation relative to the parameter by calling an Application Programming Interface (API) and passing the parameter via the API. In some embodiments, the extracted parameters are first packaged into a structured request (for example, JSON format), ensuring the API can understand and process the input. For example, if the extracted parameters are: “source”: “SFO”, “destination”: “LAX”, and “date”: “2025-06-15” some embodiments pass this request to the backend API endpoint (for example, https://api.travel.example.com/alternative-options) using an HTTP POST request. The backend API receives the parameters and queries its database or third-party travel services to find alternative travel options, such as cheaper flights or better routes for the same date and destination. The API processes the request and returns a list of recommendations in the response, such as:
{
   “alternative_flights”: [
      {
         “airline”: “United”,
         “price”: “$320”,
         “duration”: “3h 45m”
      }
   ]
}

Some embodiments then cause display of the recommendations in the Recommendation Section (for example, 608 of FIG. 6), ensuring real-time alternative suggestions to enhance the user's travel planning experience.

Some embodiments determine that the API, among a plurality of APIs, is to be called based at least in part on at least one of: the parameter, a domain, a transaction, or enough data being extracted during the extracting of the parameter. In other words, it determines which API to call among multiple APIs by using a decision engine that evaluates multiple factors, including the parameter type, domain, transaction context, and data completeness. During the parameter extraction phase, the system tags each parameter with metadata, including its type (for example, source, destination, price, etc.), corresponding domain (for example, flights. example. com), and/or transaction context (for example, flight booking, hotel reservation, etc.) in some embodiments. The decision engine matches the parameter type to a predefined API mapping table that associates each parameter type with a corresponding API endpoint. For example, if the parameter is a destination, the engine identifies that the relevant API is a hotel recommendation API for suggesting nearby accommodations.

If the parameter is associated with a specific domain, such as flights.example.com, an API linked to flight-related queries is selected (for example, flight comparison or alternative route suggestions). The decision engine cross-references the domain metadata with the API mapping table to ensure domain-specific API calls. For example, if the domain is flights.example.com, the system routes the request to an API for alternative flight options rather than a generic travel API.

Some embodiments also consider the transaction context by analyzing the sequence of extracted parameters. For instance, if the extracted parameters include source, destination, and date, the system determines that the transaction context is a flight search and therefore calls a flight comparison API. If the parameters include a confirmation number or booking reference, some embodiments recognize the context as a post-booking scenario and select an API for trip enhancements or add-ons, such as car rentals or hotel recommendations.

Before making the API call, some embodiments check if enough data has been extracted to form a complete request. It does this in some embodiments by validating the extracted parameters against the API's required fields stored in the mapping table. For example, if the API requires source, destination, and date, but only source and destination have been extracted, the system withholds the API call until the date parameter is also extracted. This ensures that only complete and valid requests are sent to the API, reducing error rates and improving response accuracy. Once all required parameters are present, the system initiates the API call and passes the parameters in the request payload, ensuring context-aware and accurate recommendations.

Some embodiments also reformat the parameter from a first format to a second format required by the API to ensure that the API processes the parameter correctly. For example, if the extracted parameter is a travel date in the format 2025-06-15 (ISO 8601 format) but the API requires the date in the format 6/15/2025 (MM/DD/YYYY), some embodiments use a data formatter module to reformat the parameter before making the API call. Some embodiments first identify the required format by referencing the API mapping table, which specifies the expected parameter format for each API endpoint. It then applies a date transformation function to convert the date from the ISO format to the required format.

Continuing with FIG. 9, some embodiments determine if the alternative option or recommendation is more optimal relative to information presented at the webpage by comparing the alternative option or recommendation with at least one of: the parameter extracted from the data source, or other data extracted from the webpage, and wherein the generating of the output at block 911 is further based on determining if the alternative option or recommendation is more optimal relative to the information presented at the webpage. After extracting the parameter (for example, flight price) from the webpage, some embodiments call the backend API and receive an alternative option (for example, a cheaper flight). It then compares the alternative option's parameter (for example, alternative flight price) with the originally extracted parameter from the webpage to determine if the alternative is more optimal (for example, if the alternative price is lower). Additionally or alternatively, some embodiments compare other extracted data such as flight duration, number of stops, or departure time to evaluate overall travel convenience.

If the alternative option is determined to be more optimal based on cost, duration, and/or other relevant metrics, some embodiments generate an output at block 911 in the form of a notification or recommendation. For example, if the alternative flight is cheaper and has fewer stops, a Floating Notification Widget (for example, 514 of FIG. 5) may be generated with a message like, “Cheaper flight available for $320 with non-stop travel.” Alternatively, if the alternative is less optimal (for example, a cheaper flight but significantly longer duration), some embodiments suppress the notification or provide contextual information to help the user make an informed decision. This intelligent comparison ensures that the output is context-aware and only recommends genuinely better options, enhancing the user's travel planning experience.

Responsive to the calling of the API and passing the parameter via the API, some embodiments receive an API response and then determine that the API response deviates from an expected result. Based at least in part on the API response deviating from the expected result, some embodiments generate a second extraction logic by using the API response to modify the prompt (for example, for an LLM to ingest). In this context, the expected result refers to the anticipated output from the API call based on the extracted parameter. Examples of expected results include a price range that matches the extracted price from the webpage, a list of alternative flights for the same source and destination, or a hotel recommendation near the extracted location. Some embodiments determine that the API response deviates from the expected result if the response falls outside predefined thresholds. For instance, if the extracted price is $350, but the API response shows a price difference of more than 20%, it is considered a deviation. Similarly, if the extracted date is 2025-06-15, but the API response suggests travel dates outside a 3-day window, some embodiments identify a discrepancy outside of an expected result. Other examples of deviations include empty responses, mismatched destinations, or inconsistent booking details, indicating potential extraction errors or outdated extraction logic.

When the API response deviates from the expected result, particular embodiments generate a second extraction logic by modifying the prompt for the LLM. It uses the API response as contextual feedback to refine the prompt, ensuring more accurate extraction logic in the next iteration. For example, if the API response indicates a mismatched date, the prompt is modified to focus on date extraction, specifying the expected format or including additional examples. If the deviation is due to missing parameters, the prompt is modified to include contextual cues or to expand the extraction scope. Some embodiments use natural language patterns to adjust the prompt, such as: “Generate a regex to extract the date in YYYY-MM-DD format, ensuring it matches the travel dates returned by the API.” The modified prompt is then fed into the LLM to generate a second extraction logic, which is validated against the data source to confirm accuracy. This feedback loop ensures the extraction logic adapts dynamically to data variations, maintaining high accuracy and consistency.

Per block 911, based at least in part on the determining of the alternative option or recommendation, some embodiments generate an output that indicates at least one of: the alternative option or the recommendation. For example, some embodiments generate and present the data under the Alternative Travel Options 508 or 514 of FIG. 5 and/or the data under the Recommended Hotels 608 of FIG. 6. Some embodiments determine that an alternative flight is cheaper and has a shorter duration compared to the originally extracted option, and then generates an output indicating the alternative option (for example, but not the original options). In some instances, the output is formatted as a notification message or recommendation card in the UI. Some embodiments construct the message by combining the extracted parameters (for example, source, destination, and date) with the alternative option details received from the API (for example, airline, price, and duration). The output is then displayed or presented.

It is understood that various embodiments of the present disclosure are not limited to parsing flight-related data sources but also extends to any suitable data, such as hotels, car rentals, vacation packages, and/or activities across URLs, web pages, and/or emails. For example, when a user visits a hotel booking website (for example, https://hotels.example.com/search?location=NYC&checkin=2025-06-15&checkout=2025-06-20), some embodiments detect the domain and query parameters, retrieves the relevant extraction logic, and extracts parameters such as location, check-in/check-out dates, and room type. Similarly, for car rentals, some embodiments apply extraction logic to URLs like https://carrentals.example.com/reserve?pickup=LAX&dropoff=SFO&date=2025-06-15, extracting parameters like pickup/drop-off locations and rental dates. For web pages, some embodiments use XPath or CSS selectors to extract details such as hotel names, nightly rates, car rental options, or bundled package deals, ensuring seamless travel booking integration.

Some embodiments also apply email parsing techniques to extract structured data from hotel confirmation emails, car rental bookings, and/or activity reservations. For example, a hotel confirmation email containing: “Hotel: Grand Resort NYC; Check-in: June 15, 2025; Check-out: June 20, 2025; Reservation Number: ABC12345” is processed using custom scripts or LLM-generated extraction logic, which identifies key fields such as hotel name, check-in/check-out dates, and reservation number. Similarly, car rental emails are parsed to extract pickup/drop-off times, vehicle type, and/or rental confirmation details. For vacation packages and activities, some embodiments detect tour bookings, restaurant reservations, or bundled deals from emails and web pages, extracting details like event date, location, and pricing. This comprehensive approach ensures that all aspects of a user's travel itinerary—beyond flights—are accurately parsed and processed, enabling intelligent recommendations and seamless trip management.

In addition or alternative to extracting source, destination, date, and price, some embodiments extract other travel-related parameters (or even non-travel related parameters) to support comprehensive trip planning and alternative recommendations. For hotels, for example, extracted parameters may include hotel name, address, check-in and check-out dates, number of rooms, room type (for example, deluxe, suite), and/or amenities (for example, free breakfast, Wi-Fi, parking availability). For flights, additional parameters include flight numbers, airline name, departure and arrival airports, departure and arrival times, layover details, baggage allowance, cabin class (for example, economy, business), and/or whether the booking is round-trip or one-way. In the case of car rentals, extracted parameters may include pickup and drop-off locations, rental duration, vehicle type (for example, sedan, SUV), rental company, and/or insurance options. Similarly, for vacation packages and activities, some embodiments extract details such as tour name, event date and time, number of guests, and booking confirmation numbers. This broad extraction capability ensures that the system captures all critical booking details, providing accurate and context-aware travel recommendations.

### Example Computing Architecture and Device

Turning now to FIG. 10, a block diagram is provided showing an example operating environment 10 in which some embodiments of the present disclosure are employed. It should be understood that this and other arrangements described herein are set forth only as examples. Other arrangements and elements (for example, machines, interfaces, functions, orders, and groupings of functions) can be used in addition to or instead of those shown, and some elements are omitted altogether for the sake of clarity. Further, many of the elements described herein are functional entities that are implemented as discrete or distributed components or in conjunction with other components, and in any suitable combination and location. Various functions described herein as being performed by an entity are carried out by hardware, firmware, and/or software. For instance, some functions are carried out by a processor executing instructions stored in memory.

Among other components not shown, example operating environment 10 includes a number of user devices, such as user devices 02a and 02b through 02n; a number of data sources (for example, databases or other data stores, such as storage 117), such as data sources 04a and 04b through 04n; server 06; sensors 03a and 07; and network(s) 110. It should be understood that environment 10 shown in FIG. 10 is an example of one suitable operating environment. Each of the components shown in FIG. 10 are implemented via any type of computing device, such as computing device 11 as described in connection to FIG. 11, for example. These components communicate with each other via network(s) 110, which includes, without limitation, a local area network (LAN) and/or a wide area network (WAN). In some implementations, network(s) 110 comprises the Internet and/or a cellular network, amongst any of a variety of possible public and/or private networks.

It should be understood that any number of user devices, servers, and data sources are employed within operating environment 10 within the scope of the present disclosure. Each comprises a single device or multiple devices cooperating in a distributed environment. For instance, server 06 is provided via multiple devices arranged in a distributed environment that collectively provide the functionality described herein. Additionally, other components not shown are also included within the distributed environment, in some embodiments.

User devices 02a and 02b through 02n can be client devices on the client side of operating environment 10, while server 06 can be on the server side of operating environment 10. Server 06 can comprise server-side software designed to work in conjunction with client-side software on user devices 02a and 02b through 02n so as to implement any combination of the features and functionalities discussed in the present disclosure. This division of operating environment 10 is provided to illustrate one example of a suitable environment, and there is no requirement for each implementation that any combination of server 06 and user devices 02a and 02b through 02n remain as separate entities. In some embodiments, the one or more servers 06 represent one or more nodes in a cloud computing environment. Consistent with various embodiments, a cloud computing environment includes a network-based, distributed data processing system that provides one or more cloud computing services. Further, a cloud computing environment can include many computers—hundreds or thousands—or more, disposed within one or more data centers and configured to share resources over the one or more network(s) 110.

In some embodiments, a user device 02a or server 06 alternatively or additionally comprises one or more web servers and/or application servers to facilitate delivering web or online content to browsers installed on a user device 02b. Often the content can include static content and dynamic content. When a client application, such as a web browser, requests a website or web application via a URL or search term, the browser typically contacts a web server to request static content or the basic components of a website or web application (for example, HTML pages, image files, video files, and the like). Application servers typically deliver any dynamic portions of web applications or business logic portions of web applications. Business logic can be described as functionality that manages communication between a user device and a data store (for example, a database). Such functionality can include business rules or workflows (for example, code that indicates conditional if/then statements, while statements, and the like to denote an order of processes).

User devices 02a and 02b through 02n comprise any type of computing device capable of use by a user. For example, in one embodiment, user devices 02a through 02n comprise the type of computing device described in relation to FIG. 11 herein. By way of example and not limitation, a user device is embodied as a personal computer (PC), a laptop computer, a mobile phone or mobile device, a smartphone, a tablet computer, a smart watch, a wearable computer, a personal digital assistant (PDA), a music player or an MP3 player, a global positioning system (GPS) or device, a video player, a handheld communications device, a gaming device or system, an entertainment system, a vehicle computer system, an embedded system controller, a camera, a remote control, a bar code scanner, a computerized measuring device, an appliance, a consumer electronic device, a workstation, or any combination of these delineated devices, or any other suitable computer device.

Data sources 04a and 04b through 04n comprise data sources and/or data systems, which are configured to make data available to any of the various constituents of operating environment 10 or system 100 described in connection to FIG. 1. Examples of data source(s) 04a through 04n include one or more of a database, a file, data structure, corpus, or other data store. Data sources 04a and 04b through 04n are discrete from user devices 02a and 02b through 02n and server 06, or the data sources are incorporated and/or integrated into at least one of those components in some embodiments. In one embodiment, data sources 04a through 04n comprise sensors (such as sensors 03a and 07), which are integrated into or associated with the user device(s) 02a, 02b, or 02n or server 06 in some embodiments.

In some embodiments, operating environment 9 is utilized to implement one or more of the components of the system 100, described in FIG. 1. Operating environment 10 also can be utilized for implementing aspects of processes 700, 800, 900 and/or any other functionality as described in connection with FIGS. 1-10.

Having described various implementations, an exemplary computing environment suitable for implementing embodiments of the disclosure is now described. With reference to FIG. 11, an exemplary computing device is provided and referred to generally as computing device 11. The computing device 11 is but one example of a suitable computing environment and is not intended to suggest any limitation as to the scope of use or functionality of embodiments of the disclosure, and nor should the computing device 11 be interpreted as having any dependency or requirement relating to any one or combination of components illustrated.

Turning to FIG. 11, computing device 11 includes a bus 10 that directly or indirectly couples the following devices: memory 12, one or more processors 14, one or more presentation components 16, one or more input/output (I/O) ports 18, one or more I/O components 20, an illustrative power supply 22, and a hardware accelerator 26. Bus 10 represents what can be one or more buses (such as an address bus, data bus, or combination thereof). Although the various blocks of FIG. 11 are shown with lines for the sake of clarity, in reality, these blocks represent logical, not necessarily actual, components. For example, one can consider a presentation component such as a display device to be an I/O component. Also, processors have memory. The inventors hereof recognize that such is the nature of the art and reiterate that the diagram of FIG. 11 is merely illustrative of an exemplary computing device that can be used in connection with one or more embodiments of the present disclosure. Distinction is not made between such categories as “workstation,” “server,” “laptop,” “handheld device,” or other computing device, as all are contemplated within the scope of FIG. 11 and with reference to “computing device.”

Computing device 11 typically includes a variety of computer-readable media. Computer-readable media can be any available media that can be accessed by computing device 11 and includes both volatile and nonvolatile media, removable and non-removable media. By way of example, and not limitation, computer-readable media comprises computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 11. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 12 includes computer storage media in the form of volatile and/or nonvolatile memory. The memory is removable, non-removable, or a combination thereof. Exemplary hardware devices include solid-state memory, hard drives, optical-disc drives, or other hardware. Computing device 11 includes one or more processors 14 that read data from various entities such as memory 12 or I/O components 20. Presentation component(s) 16 presents data indications to a user or other device. Exemplary presentation components include a display device, speaker, printing component, vibrating component, and the like.

The I/O ports 18 allow computing device 11 to be logically coupled to other devices, including I/O components 20, some of which are built-in, in some instances. Illustrative components include a microphone, joystick, game pad, satellite dish, scanner, printer, wireless device, and the like. The I/O components 20 provide a natural user interface (NUI) that processes air gestures, voice, or other physiological inputs generated by a user in some embodiments. In some instances, inputs are transmitted to an appropriate network element for further processing. An NUI can implement any combination of speech recognition, touch and stylus recognition, facial recognition, biometric recognition, gesture recognition both on screen and adjacent to the screen, air gestures, head and eye tracking, and touch recognition associated with displays on the computing device 11. The computing device 11 can be equipped with depth cameras, such as stereoscopic camera systems, infrared camera systems, RGB camera systems, and combinations of these, for gesture detection and recognition. Additionally, the computing device 11 can be equipped with accelerometers or gyroscopes that enable detection of motion. The output of the accelerometers or gyroscopes can be provided to the display of the computing device 11 to render immersive augmented reality or virtual reality.

Some embodiments of computing device 11 include one or more radio(s) 24 (or similar wireless communication components). The radio 24 transmits and receives radio or wireless communications. The computing device 11 can be a wireless terminal adapted to receive communications and media over various wireless networks. Computing device 11 can communicate via wireless protocols, such as code-division multiple access (“CDMA”), global system for mobiles (“GSM”), or time-division multiple access (“TDMA”), as well as others, to communicate with other devices. The radio communications can be a short-range connection, a long-range connection, or a combination of both a short-range and a long-range wireless telecommunications connection. The terms “short” and “long” in regards to types of connections do not refer to the spatial relation between two devices. Rather, these terms generally refer to short range and long range as different categories, or types, of connections (i.e., a primary connection and a secondary connection). A short-range connection can include, by way of example and not limitation, a Wi-Fi® connection to a device (for example, mobile hotspot) that provides access to a wireless communications network, such as a WLAN connection using the 802.11 protocol; a Bluetooth connection to another computing device is a second example of a short-range connection, or a near-field communication connection. A long-range connection can include a connection using, by way of example and not limitation, one or more of CDMA, GPRS, GSM, TDMA, and 802.16 protocols.

Hardware accelerator 26 represents any suitable hardware component (for example, GPU) that offloads one or more tasks (for example, from a CPU) to accelerate or speed up the task. In some embodiments, the hardware accelerator 26 represents a Graphics Processing Unit (GPU), field-programmable gate arrays (FPGAs), application-specific integrated circuits (ASICs), a Tensor Processing Unit (TPU), a sound card, or any suitable hardware component.

### Other Embodiments

In some embodiments, a system, such as the computerized system described in any of the embodiments above, comprises at least one computer processor and one or more computer storage media storing computer-useable instructions that, when used by the at least one computer processor, cause the at least one computer processor to perform operations. The operations comprise obtaining a data source that includes at least one of: a Uniform Resource Locator (URL), an app page or webpage, or an email. The operations further comprise providing the data source and a prompt as input to a language model, wherein the language model generates extraction logic, the extraction logic including at least one of a rule, a pattern, or an instruction defining how information should be extracted from the data source. The operations further comprise, based at least in part on the language model generating the extraction logic, extracting a parameter from the data source by applying the generated extraction logic to the data source; determining an alternative option or recommendation relative to the parameter by calling an Application Programming Interface (API) and passing the parameter via the API. The operations further comprise, based at least in part on the determining of the alternative option or recommendation, generating an output that indicates at least one of: the alternative option or recommendation, or the parameter.

Advantageously, these and other embodiments, as described herein, improve the efficiency and accuracy of extracting and processing data from diverse sources by leveraging advanced language models to generate dynamic extraction logic. This approach reduces the need for manual rule creation and maintenance, enhances scalability, and ensures real-time adaptability to changing data formats, thereby providing more accurate and contextually relevant recommendations and output.

In any combination of the above embodiments of the system, the data source includes the URL and the extraction logic includes a regular expression (regex), and the operations further comprise: collecting a plurality of URLs from logs from a plurality of domains, the URL being included in the plurality of URLs, and the language model generates the regex based on processing the plurality of URLs

In any combination of the above embodiments of the system, the operations further comprise detecting the data source being accessed by a user device during runtime. The operations further comprise, based at least in part on the detecting of the data source being accessed by the user device during runtime, accessing, from a repository, the extraction logic and engaging in the extracting of the parameter from the data source by applying the generated extraction logic to the data source.

In any combination of the above embodiments of the system, the operations further comprise determining that the API, among a plurality of APIs, is to be called based at least in part on at least one of: the parameter, a domain, a transaction, or enough data being extracted during the extracting of the parameter.

In any combination of the above embodiments of the system, the operations further comprise reformatting the parameter from a first format to a second format required by the API to ensure that the API processes the parameter correctly.

In any combination of the above embodiments of the system, the operations further comprise determining if the alternative option or recommendation is more optimal relative to information presented at the webpage by comparing the alternative option or recommendation with at least one of: the parameter extracted from the data source, or other data extracted from the webpage, and the generating of the output is further based on determining if the alternative option or recommendation is more optimal relative to the information presented at the webpage.

In any combination of the above embodiments of the system, the operations further comprise responsive to the calling of the API and passing the parameter via the API, receiving an API response; determining that the API response deviates from an expected result; and based at least in part on the API response deviating from the expected result, generating a second extraction logic by using the API response to modify the prompt.

In any combination of the above embodiments of the system, the data source includes the webpage and the extraction logic includes at least one of an Extensible Markup Language Path (XPath) selector or a Cascading Style Sheets (CSS) selector, and the operations further comprise collecting HyperText Markup Language (HTML) page content of a plurality of websites, the webpage being included in the HTML page content, and the language model generates the XPath selector or CSS selector based on processing the HTML page content of a plurality of websites.

In any combination of the above embodiments of the system, the data source includes the email and the extraction logic includes computer programming code, and the operations further comprise collecting a plurality of emails from a domain, the email being included in the plurality of emails, and the language model generates the computer program code based on processing the plurality of emails.

In any combination of the above embodiments of the system, the operations further comprise compiling or interpreting the computer programming code and associating the computer programming code with the domain; and confirming that the computer programming code consistently extracts correct parameters by validating the compiled or interpreted computer programming code against at least a second email.

In any combination of the above embodiments of the system, the data source represents travel-related information, and the parameter comprises at least one of: source and destination locations, travel dates, pricing information, or booking details, and the alternative option or recommendation includes at least one of: an alternative travel suggestion, a price comparison, or an additional travel-related recommendation, and the output includes at least one of a notification of the alternative travel suggestion, a pre-populated booking suggestion, or an enhanced travel itinerary including a suggested experience or service.

In any combination of the above embodiments of the system, the extracting of the parameter from the data source by applying the generated extraction logic to the data source is based on one of: matching, via a regular expression (regex), a key in the regex to a key in the URL and responsively extracting a value representing the parameter in the URL. The operations further comprise specifying a path or rule, via an Extensible Markup Language Path (XPath) selector or a Cascading Style Sheets (CSS) selector, for navigating through the webpage's Document Object Model (DOM) tree and locating a node containing the parameter; or scanning, using a custom script, content in the email for a predetermined field representing the parameter by identifying a key character in the script that corresponds to a key character in the email and extracting a value associated with the parameter using a defined pattern.

In some embodiments, a computer-implemented method is provided. The method comprises detecting a travel-related data source of information accessed by a user during runtime, the data source being one or more of: a URL associated with a travel-related domain, a webpage containing travel-related content, or an email containing travel-related booking details. The method further comprises, based at least in part on the travel-related data source of information, accessing, via a repository, a data record that includes extraction logic, the extraction logic having been generated via a language model, the extraction logic including at least one of a rule, a pattern, or an instruction defining how information should be extracted from the travel-related data source. The method further comprises, in response to the accessing of the data record that includes the extraction logic, extracting a parameter from the travel-related data source by applying the generated extraction logic to the travel-related data source, the parameter comprising at least one of: source and destination locations, a travel date, pricing information, or a booking detail. The method further comprises, in response to the extracting of the parameter from the data source, determining an alternative travel option or travel recommendation relative to the parameter by calling an Application Programming Interface (API) and passing the parameter via the API. The method further comprises, based at least in part on the determining of the alternative travel option or travel recommendation, generating an output that indicates at least one of: the alternative travel option or travel recommendation, or the parameter.

Advantageously, these and other embodiments, as described herein, improve the efficiency and accuracy of processing travel-related information by leveraging advanced language models to generate dynamic extraction logic. This approach reduces the need for manual rule creation and maintenance, enhances scalability, and ensures real-time adaptability to changing data formats, thereby providing more accurate and contextually relevant travel recommendations and output.

In any combination of the above embodiments of the computer-implemented method, the method further comprises determining that the API, among a plurality of APIs, is to be called based at least in part on at least one of: the parameter, a domain, a transaction, or enough data being extracted during the extracting of the parameter.

In any combination of the above embodiments of the computer-implemented method, the method further comprises reformatting the parameter from a first format to a second format required by the API to ensure that the API processes the parameter correctly.

In any combination of the above embodiments of the computer-implemented method, the method further comprises determining if the alternative option or recommendation is more optimal relative to information presented at the webpage by comparing the alternative option or recommendation with at least one of: the parameter extracted from the data source, or other data extracted from the webpage, and the generation of the output is further based on determining if the alternative option or recommendation is more optimal relative to the information presented at the webpage.

In any combination of the above embodiments of the computer-implemented method, the method further comprises responsive to the calling of the API and passing the parameter via the API, receiving an API response. The method further comprises determining that the API response deviates from an expected result; and based at least in part on the API response deviating from the expected result, generating a second extraction logic by using the API response to modify a prompt.

In any combination of the above embodiments of the computer-implemented method, the method further comprises generating, via a language model and prior to the detecting of the travel-related data source of information, the extraction logic for each data sample from a plurality of data sources, the extraction logic comprising at least one of: a regular expression (regex), an Extensible Markup Language Path (XPath) selector, a custom script for an email, or a Cascading Style Sheets (CSS) selector.

In some embodiments, computer storage media are provided having computer-executable instructions embodied thereon that, when executed, by one or more processors, cause the one or more processors to perform operations. The operations comprise collecting a data sample from a plurality of data sources, the plurality of data sources including at least one of: a Uniform Resource Locator (URL), a webpage, an app page, or an email. The operations further comprise generating, via a language model, extraction logic for each data sample from the plurality of data sources, the extraction logic comprising at least one of: a regular expression (regex), an Extensible Markup Language Path (XPath) selector, a custom script for the email, or a Cascading Style Sheets (CSS) selector. The operations further comprise, in response to the generating, via the language model, the extraction logic, storing the extraction logic in a repository, wherein the extraction logic is associated with at least one corresponding domain or subdomain for subsequent retrieval.

Advantageously, these and other embodiments, as described herein, improve the efficiency and accuracy of data extraction from diverse sources by leveraging advanced language models to generate dynamic extraction logic. This approach reduces the need for manual rule creation and maintenance, enhances scalability, and ensures real-time adaptability to changing data formats, thereby providing more accurate and contextually relevant data extraction and storage.

In any combination of the above embodiments of the computer storage media, the operations further comprise subsequent to the storing of the extraction logic in the repository, detecting a data source accessed by a user device during runtime, the data source being at least one of: a URL accessed via a browser or app, an HTML page rendered in a browser or app, or an email received by a user of the user device. The operations further comprise, in response to detecting the data source accessed by the user device during runtime, retrieving the extraction logic stored in the repository. The operations further comprise, in response to the retrieving of the extraction logic stored in the repository, extracting a parameter by applying the extraction logic to the detected data source; and in response to the extracting of the parameter, providing the extracted parameter to an external system that is configured to generate an alternative option or recommendation relative to the parameter.

### Remarks

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities are carried out by hardware, firmware, and/or software, as described below. For instance, various functions are carried out by a processor executing instructions stored in memory. As such, other arrangements and elements (for example, machines, interfaces, functions, orders, groupings of functions, and the like.) can be used in addition to or instead of those shown.

Embodiments of the present disclosure have been described with the intent to be illustrative rather than restrictive. Embodiments described in the paragraphs above can be combined with one or more of the specifically described alternatives. In particular, an embodiment that is claimed can contain a reference, in the alternative, to more than one other embodiment. The embodiment that is claimed can specify a further limitation of the subject matter claimed. Alternative embodiments will become apparent to readers of this disclosure after and because of reading it. Alternative means of implementing the aforementioned can be completed without departing from the scope of the claims below. Certain features and subcombinations are of utility and can be employed without reference to other features and subcombinations and are contemplated within the scope of the claims.

As used herein, the term “set” is employed to refer to an ordered (i.e., sequential) or an unordered (i.e., non-sequential) collection of objects (or elements), such as but not limited to data elements (for example, events, clusters of events, and the like). A set includes N elements, where N is any non-negative integer. That is, a set includes 1, 2, 3, and N objects and/or elements, where N is a positive integer with no upper bound. Therefore, as used herein, a set can include only a single element. In other embodiments, a set includes a number of elements that is significantly greater than one, two, or three elements. As used herein, the term “subset” is a set that is included in another set. A subset can be, but is not required to be, a proper or strict subset of the other set that the subset is included in. That is, if set B is a subset of set A, then in some embodiments, set B is a proper or strict subset of set A. In other embodiments, set B is a subset of set A, but not a proper or a strict subset of set A.

What is claimed is:

1. A system comprising:
at least one computer processor; and
one or more computer storage media storing computer-useable instructions that, when used by the at least one computer processor, cause the at least one computer processor to perform operations comprising:
obtaining a data source that includes at least one of: a Uniform Resource Locator (URL), an app page or webpage, or an email;
providing the data source and a prompt as input to a language model, wherein the language model generates extraction logic, the extraction logic including at least one of a rule, a pattern, or an instruction defining how information should be extracted from the data source;
based at least in part on the language model generating the extraction logic, extracting a parameter from the data source by applying the generated extraction logic to the data source;
determining an alternative option or recommendation relative to the parameter by calling an Application Programming Interface (API) and passing the parameter via the API; and
based at least in part on the determining of the alternative option or recommendation, generating an output that indicates at least one of: the alternative option or recommendation, or the parameter.

2. The system of claim 1, wherein the data source includes the URL and the extraction logic includes a regular expression (regex), and wherein the operations further comprise:
collecting a plurality of URLs from logs from a plurality of domains, the URL being included in the plurality of URLs, and wherein the language model generates the regex based on processing the plurality of URLs.

3. The system of claim 1, wherein the operations further comprise:
detecting the data source being accessed by a user device during runtime; and
based at least in part on the detecting of the data source being accessed by the user device during runtime, accessing, from a repository, the extraction logic and engaging in the extracting of the parameter from the data source by applying the generated extraction logic to the data source.

4. The system of claim 1, wherein the operations further comprise:
determining that the API, among a plurality of APIs, is to be called based at least in part on at least one of: the parameter, a domain, a transaction, or enough data being extracted during the extracting of the parameter.

5. The system of claim 1, wherein the operations further comprise:
reformatting the parameter from a first format to a second format required by the API to ensure that the API processes the parameter correctly.

6. The system of claim 1, wherein the operations further comprise:
determining if the alternative option or recommendation is more optimal relative to information presented at the webpage by comparing the alternative option or recommendation with at least one of: the parameter extracted from the data source, or other data extracted from the webpage, and wherein the generating of the output is further based on determining if the alternative option or recommendation is more optimal relative to the information presented at the webpage.

7. The system of claim 1, wherein the operations further comprise:
responsive to the calling of the API and passing the parameter via the API, receiving an API response;
determining that the API response deviates from an expected result; and
based at least in part on the API response deviating from the expected result, generating a second extraction logic by using the API response to modify the prompt.

8. The system of claim 1, wherein the data source includes the webpage and the extraction logic includes at least one of an Extensible Markup Language Path (XPath) selector or a Cascading Style Sheets (CSS) selector, and wherein the operations further comprise:
collecting HyperText Markup Language (HTML) page content of a plurality of websites, the webpage being included in the HTML page content, and
wherein the language model generates the XPath selector or CSS selector based on processing the HTML page content of a plurality of websites.

9. The system of claim 1, wherein the data source includes the email and the extraction logic includes computer programming code, and wherein the operations further comprise:
collecting a plurality of emails from a domain, the email being included in the plurality of emails, and
wherein the language model generates the computer program code based on processing the plurality of emails.

10. The system of claim 9, wherein the operations further comprise:
compiling or interpreting the computer programming code and associating the computer programming code with the domain; and
confirming that the computer programming code consistently extracts correct parameters by validating the compiled or interpreted computer programming code against at least a second email.

11. The system of claim 1, wherein the data source represents travel-related information, and wherein the parameter comprises at least one of: source and destination locations, travel dates, pricing information, or booking details, and wherein the alternative option or recommendation includes at least one of: an alternative travel suggestion, a price comparison, or an additional travel-related recommendation, and wherein the output includes at least one of a notification of the alternative travel suggestion, a pre-populated booking suggestion, or an enhanced travel itinerary including a suggested experience or service.

12. The system of claim 1, wherein the extracting of the parameter from the data source by applying the generated extraction logic to the data source is based on one of:
matching, via a regular expression (regex), a key in the regex to a key in the URL and responsively extracting a value representing the parameter in the URL;
specifying a path or rule, via an Extensible Markup Language Path (XPath) selector or a Cascading Style Sheets (CSS) selector, for navigating through the webpage's Document Object Model (DOM) tree and locating a node containing the parameter; or
scanning, using a custom script, content in the email for a predetermined field representing the parameter by identifying a key character in the script that corresponds to a key character in the email and extracting a value associated with the parameter using a defined pattern.

13. A computer-implemented method comprising:
detecting a travel-related data source of information accessed by a user during runtime, the data source being one or more of: a URL associated with a travel-related domain, a webpage containing travel-related content, or an email containing travel-related booking details;
based at least in part on the travel-related data source of information, accessing, via a repository, a data record that includes extraction logic, the extraction logic having been generated via a language model, the extraction logic including at least one of a rule, a pattern, or an instruction defining how information should be extracted from the travel-related data source;
in response to the accessing of the data record that includes the extraction logic, extracting a parameter from the travel-related data source by applying the generated extraction logic to the travel-related data source, the parameter comprising at least one of: source and destination locations, a travel date, pricing information, or a booking detail;
in response to the extracting of the parameter from the data source, determining an alternative travel option or travel recommendation relative to the parameter by calling an Application Programming Interface (API) and passing the parameter via the API; and
based at least in part on the determining of the alternative travel option or travel recommendation, generating an output that indicates at least one of: the alternative travel option or travel recommendation, or the parameter.

14. The computer-implemented method of claim 13, further comprising:
determining that the API, among a plurality of APIs, is to be called based at least in part on at least one of: the parameter, a domain, a transaction, or enough data being extracted during the extracting of the parameter.

15. The computer-implemented method of claim 13, further comprising:
reformatting the parameter from a first format to a second format required by the API to ensure that the API processes the parameter correctly.

16. The computer-implemented method of claim 13, further comprising:
determining if the alternative option or recommendation is more optimal relative to information presented at the webpage by comparing the alternative option or recommendation with at least one of: the parameter extracted from the data source, or other data extracted from the webpage, and
wherein the generation of the output is further based on determining if the alternative option or recommendation is more optimal relative to the information presented at the webpage.

17. The computer-implemented method of claim 13, further comprising:
responsive to the calling of the API and passing the parameter via the API, receiving an API response;
determining that the API response deviates from an expected result; and based at least in part on the API response deviating from the expected result, generating a second extraction logic by using the API response to modify a prompt.

18. The computer-implemented method of claim 13, further comprising generating, via a language model and prior to the detecting of the travel-related data source of information, the extraction logic for each data sample from a plurality of data sources, the extraction logic comprising at least one of: a regular expression (regex), an Extensible Markup Language Path (XPath) selector, a custom script for an email, or a Cascading Style Sheets (CSS) selector.

19. One or more computer storage media having computer-executable instructions embodied thereon that, when executed, by one or more processors, cause the one or more processors to perform operations comprising:
collecting a data sample from a plurality of data sources, the plurality of data sources including at least one of: a Uniform Resource Locator (URL), a webpage, an app page, or an email;
generating, via a language model, extraction logic for each data sample from the plurality of data sources, the extraction logic comprising at least one of: a regular expression (regex), an Extensible Markup Language Path (XPath) selector, a custom script for the email, or a Cascading Style Sheets (CSS) selector; and
in response to the generating, via the language model, the extraction logic, storing the extraction logic in a repository, wherein the extraction logic is associated with at least one corresponding domain or subdomain for subsequent retrieval.

20. One or more computer storage media of claim 19, wherein the operations further comprise:
subsequent to the storing of the extraction logic in the repository, detecting a data source accessed by a user device during runtime, the data source being at least one of: a URL accessed via a browser or app, an HTML page rendered in a browser or app, or an email received by a user of the user device;
in response to detecting the data source accessed by the user device during runtime, retrieving the extraction logic stored in the repository;
in response to the retrieving of the extraction logic stored in the repository, extracting a parameter by applying the extraction logic to the detected data source; and
in response to the extracting of the parameter, providing the extracted parameter to an external system that is configured to generate an alternative option or recommendation relative to the parameter.
